(19) United States
(12) Patent Application Publication
(10) Pub. No.: US 2026/0230507 A1
(43) Pub. Date: Aug. 6, 2026

(54) DEPLOYING A BRANCH OF A MAIN CODEBASE BASED ON SECURITY POLICY COMPLIANCE SINCE CREATION OF THE BRANCH

(71) Applicant: Microsoft Technology Licensing, LLC, Redmond, WA (US)

(72) Inventors: Jose Luis MENDOZA AZANZA, Kirkland, WA (US); Alexander Geoffrey HOWELLS, Sammamish, WA (US); Oleg SURMACHEV, Arlington, WA (US); Vishwa Shobhit SAHAY, Redmond, WA (US); Haixia LING, Bellevue, WA (US); Mikhail DEMYANYUK, Redmond, WA (US); Erica Miyisha TURNER-SUMIYOSHI, Kennesaw, GA (US); Haris Farhan MOHAMMAD, Kirkland, WA (US)

(21) Appl. No.: 19/045,506

(22) Filed: Feb. 4, 2025

(51) Int. Cl. H04L 9/40; G06F 8/71

(52) U.S. Cl. CPC H04L 63/20; G06F 8/71

(57) ABSTRACT

Techniques are described herein that are capable of deploying a branch of a main codebase based on compliance of the branch with a security policy since creation of the branch(es). A first branch of a main codebase is stored in a designated store and a second branch of the main codebase is not stored in the designated store as a result of the first branch complying with a security policy throughout a first time period since creation of the first branch and the second branch failing to comply with the security policy during a second time period since creation of the second branch. As a result of the first branch being stored in the designated store and complying with the security policy throughout the first time period, the first branch is converted into a deployable code branch, and the deployable code branch is deployed.

### BACKGROUND

A main codebase is a primary version of software. The primary version typically includes the most stable and up-to-date code that is ready to be released to end users of the software. Releasing software is making the software accessible to end users of the software. Developers often create branches of the main codebase (i.e., secondary versions of the software), which enables the developers to work on features of the software, bug fixes, and/or experiments independently from the main codebase. Accordingly, changes in the branches do not affect the main codebase unless the changes are incorporated into the main codebase.

Security of the main codebase may be compromised by incorporating a branch that is created or modified by a malicious entity into the main codebase. For instance, the malicious entity may inject malicious code into the branch before incorporating the branch into the main codebase. In one example scenario, the malicious entity obtains authority to create or modify the branch using credentials of a legitimate developer of the software, and the malicious entity is able to incorporate the malicious code from the branch into the main codebase without a security check or by relying on ownership of the branch being attributed to the legitimate developer.

Deploying such a compromised main codebase may cause substantial harm to end users of the software. For instance, deploying the compromised main codebase may cause malicious code introduced into the compromised main codebase by a malicious entity to perform malicious operations on computing systems of the end users as a result of the compromised main codebase being released to the end users.

### SUMMARY

It may be desirable to confirm that a branch of a main codebase has complied with a security policy since creation of the branch prior to deploying the branch. In an aspect, compliance of the branch with the security policy is established as a prerequisite for deploying the branch. In accordance with this aspect, the prerequisite may be defined in (e.g., by) the security policy. Deployment of a branch includes providing the branch to a production environment. A production environment is an environment from which software (e.g., the aforementioned branch) is made accessible to an end user of the software. In an aspect, the deployment of the branch further includes making the branch operational. Confirming that the branch complies with the security policy prior to deployment of the branch may reduce a likelihood that the branch has been created or modified by a malicious entity. For instance, the security policy may require that creation of the branch and/or modifications to the branch are approved using a pull request prior to incorporating the branch or the modifications into the main codebase. A pull request is a request to create a branch of a main codebase or to make a change to the branch. In an aspect, the pull request includes a description of the branch that is to be created or the modification that is to be made to the branch. Creating the pull request establishes that approval of the pull request is a prerequisite for merging the branch or the modification into the main codebase. In an aspect, creating the pull request enables people (e.g., developers) associated with the main codebase to review and discuss the branch or the modification prior to the branch or the modification becoming part of the main codebase.

A security policy is a policy that is configured to provide security with regard to software. For instance, the security may pertain to integrity, confidentiality, and/or availability of the software. In an aspect, the security policy includes guideline(s) and/or rule(s) that are configured to maintain or increase the security of the software, end users of the software, data that is processed by the software, and/or data that is generated by the software. The security policy may specify users (e.g., groups of users) who are authorized to access the software; an authentication procedure used to authenticate the users; a requirement to encrypt data processed or generated by the software; a procedure used to fix vulnerabilities in the software; a coding standard or best practice for development of the software; a law, regulation, or industry standard with which the software must comply, and so on.

Various approaches are described herein for, among other things, deploying branch(es) of a main codebase based on compliance of the branch(es) with a security policy since creation of the branch(es). In a first example approach, as a result of a first branch of a main codebase undergoing an official build, the first branch is stored in a designated store. As a result of verifying that a second branch of the main codebase has complied with a security policy since creation of the second branch, the second branch is stored in the designated store. A determination is made that a deployment criterion is satisfied by verifying that the first branch and the second branch are stored in the designated store and that the first branch and the second branch have complied with the security policy since being stored in the designated store. As a result of the deployment criterion being satisfied, a first deployable code branch and a second deployable code branch are generated by building the first branch and the second branch, respectively. As a result of a request to deploy a build of the main codebase being received, the first deployable code branch and the second deployable code branch are deployed.

In a second example approach, a first branch of a main codebase is stored in a designated store, instead of storing a second branch of the main codebase in the designated store, as a result of the first branch continuously complying with a security policy since creation of the first branch and the second branch failing to continuously comply with the security policy since creation of the second branch. As a result of the first branch of the main codebase being stored in the designated store and the first branch continuing to comply with the security policy since the first branch was stored in the designated store, the first branch is converted into a deployable code branch by building the first branch. In response to a request to deploy a build of the main codebase, the deployable code branch is deployed.

In a third example approach, at a first time instance, a determination is made whether first, second, and third branches of a main codebase comply with a security policy throughout respective first, second, and third time periods that begin at creation of the first, second, and third branches and that end at the first time instance. The first and second branches of the main codebase are stored in a designated store, instead of storing the third branch in the designated store, as a result of the first and second branches complying with the security policy throughout the respective first and second time periods and the third branch failing to comply with the security policy during the respective third time period. At a second time instance, the first branch is converted into a deployable code branch by building the first branch, instead of building the second branch, as a result of the first branch being stored in the designated store and the first branch complying with the security policy throughout a fourth time period and the second branch failing to comply with the security policy during the fourth time period. The fourth time period begins at the first time instance and ends at the second time instance. As a result of a request to deploy a build of the main codebase being received, the deployable code branch is deployed.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Moreover, it is noted that the invention is not limited to the specific embodiments described in the Detailed Description and/or other sections of this document. Such embodiments are presented herein for illustrative purposes only. Additional embodiments will be apparent to persons skilled in the relevant art(s) based on the teachings contained herein.

### BRIEF DESCRIPTION OF THE DRAWINGS/FIGURES

The accompanying drawings, which are incorporated herein and form part of the specification, illustrate embodiments of the present invention and, together with the description, further serve to explain the principles involved and to enable a person skilled in the relevant art(s) to make and use the disclosed technologies.

FIG. 1 is a block diagram of an example security policy compliance-based deployment system in accordance with an embodiment.

FIG. 2 depicts a flowchart of an example method for deploying branches of a main codebase based on security policy compliance since creation of the branches in accordance with an embodiment.

FIG. 3 is a block diagram of an example computing system in accordance with an embodiment.

FIGS. 4 and 6 depict flowcharts of example methods for deploying a branch of a main codebase based on security policy compliance since creation of the branch in accordance with embodiments.

FIGS. 5 and 7 are block diagrams of other example computing systems in accordance with embodiments.

FIG. 8 depicts an example computer in which embodiments may be implemented.

The features and advantages of the disclosed technologies will become more apparent from the detailed description set forth below when taken in conjunction with the drawings, in which like reference characters identify corresponding elements throughout. In the drawings, like reference numbers generally indicate identical, functionally similar, and/or structurally similar elements. The drawing in which an element first appears is indicated by the leftmost digit(s) in the corresponding reference number.

### DETAILED DESCRIPTION

### I. Example Embodiments

It may be desirable to confirm that a branch of a main codebase has complied with a security policy since creation of the branch prior to deploying the branch. In an aspect, compliance of the branch with the security policy is established as a prerequisite for deploying the branch. In accordance with this aspect, the prerequisite may be defined in (e.g., by) the security policy. Deployment of a branch includes providing the branch to a production environment. A production environment is an environment from which software (e.g., the aforementioned branch) is made accessible to an end user of the software. In an aspect, the deployment of the branch further includes making the branch operational. Confirming that the branch complies with the security policy prior to deployment of the branch may reduce a likelihood that the branch has been created or modified by a malicious entity. For instance, the security policy may require that creation of the branch and/or modifications to the branch are approved using a pull request prior to incorporating the branch or the modifications into the main codebase. A pull request is a request to create a branch of a main codebase or to make a change to the branch. In an aspect, the pull request includes a description of the branch that is to be created or the modification that is to be made to the branch. Creating the pull request establishes that approval of the pull request is a prerequisite for merging the branch or the modification into the main codebase. In an aspect, creating the pull request enables people (e.g., developers) associated with the main codebase to review and discuss the branch or the modification prior to the branch or the modification becoming part of the main codebase.

A security policy is a policy that is configured to provide security with regard to software. For instance, the security may pertain to integrity, confidentiality, and/or availability of the software. In an aspect, the security policy includes guideline(s) and/or rule(s) that are configured to maintain or increase the security of the software, end users of the software, data that is processed by the software, and/or data that is generated by the software. The security policy may specify users (e.g., groups of users) who are authorized to access the software; an authentication procedure used to authenticate the users; a requirement to encrypt data processed or generated by the software; a procedure used to fix vulnerabilities in the software; a coding standard or best practice for development of the software; a law, regulation, or industry standard with which the software must comply, and so on.

Example embodiments described herein are capable of deploying branch(es) of a main codebase based on compliance of the branch(es) with a security policy since creation of the branch(es). Example techniques described herein have a variety of benefits as compared to conventional techniques for deploying branch(es) of a main codebase. For instance, the example techniques are capable of increasing security of the main codebase, users of the main codebase, data processed by the main codebase, and/or data generated by the main codebase. In a first aspect, the example techniques are capable of increasing the security by ensuring that branches that are incorporated into the main codebase comply with the security policy for a period of time that extends from creation of the branches to deployment of the branches. Accordingly, the example techniques may ensure that the branches comply with the security policy throughout development of the branches. The example techniques are capable of determining whether the branches of the main codebase comply (e.g., continuously comply) with the security policy more accurately, precisely, and/or reliably than conventional techniques. For instance, the example techniques may determine whether the branches of the main codebase comply with the security policy with a greater statistical accuracy and/or precision than the conventional techniques.

In a second aspect, the example techniques are capable of increasing the security by storing branch(es) of the main codebase that comply with the security policy in a designated store and confirming that the branch(es) are stored in the designated store as a prerequisite for building the branch(es). In accordance with this aspect, branches of the main codebase that are not stored in the designated store are not built and therefore are not deployed. In an example, branches that are not stored in the designated store are prevented from being built. In accordance with this example, by preventing the branches that are not stored in the designated store from being built, those branches are prevented from being deployed.

In a third aspect, the example techniques increase the security by reducing a likelihood that non-validated code is signed with a production certificate and released to end users. In an example, a security policy requires code in a branch of the main codebase to be validated by calling a pull request prior to merging the code into the main codebase. In accordance with this example, a failure to call the pull request prevents the code from being merged into the main codebase and therefore prevents the code from being released to the end users.

In a fourth aspect, the example techniques increase the security by detecting whether a security policy was turned off prior to a branch of the main codebase being created or modified and then turned on after the branch is created or modified. In an example, the security policy requires that the security policy remains turned on for a time period that begins at creation of the branch and that ends at a time instance at which the branch is to be deployed. In accordance with this example, the security policy being turned off and then turned on during the time period results in a failure of the branch to comply with the security policy. In further accordance with this example, the branch is not deployed as a result of the branch failing to comply with the security policy.

The example techniques are capable of reducing an amount of time and/or resources (e.g., processor cycles, memory, network bandwidth) that is consumed (e.g., by a computing system) to deploy branch(es) of a main codebase. In a first aspect, the example techniques reduce the amount of time and/or resources that is consumed by making a determination whether security of the branch(es) is compromised (e.g., by a malicious entity) more accurately, precisely, and/or reliably than conventional techniques. For instance, the example techniques may make the determination with a greater statistical accuracy and/or precision than the conventional techniques. In an example, the determination is based on (e.g., based at least on) whether the branch(es) comply with a security policy for a period of time that extends from creation of the branch(es) until a time instance at which the branch(es) are to be deployed. A branch complying with the security policy throughout the time period weighs against determining that the security of the branch is compromised, whereas the branch failing to comply with the security policy during the time period weighs in favor of determining that the security of the branch is compromised. For instance, the branch complying with the security policy throughout the time period may indicate a relatively low likelihood that the security of the branch is compromised.

In a second aspect, the example techniques reduce the amount of time and/or resources that is consumed to deploy a branch of the main codebase by incrementally (e.g., periodically) evaluating security of the branch over time. The security of the branch over earlier time periods need not be re-evaluated when evaluating the security of the branch over later time periods, which may reduce the amount of time and/or resources that is consumed to evaluate the security of the branch over time.

In an example, the security of the branch is evaluated over a first incremental evaluation period to determine whether the branch is to be stored in a designated store. The first incremental evaluation period is defined to extend from a first time instance at which the branch is created to a second time instance at which the branch is to be stored in the designated store. In an implementation of this example, evaluation of the security over the first incremental evaluation period includes determining whether the branch complies with a security policy throughout the first incremental evaluation period. In accordance with this implementation, the branch complying with the security policy throughout the first incremental evaluation period indicates that the branch is to be stored in the designated store. In further accordance with this implementation, the branch failing to comply with the security policy during the first incremental evaluation period indicates that the branch is not to be stored in the designated store.

In accordance with this example, the security of the branch is evaluated over a second incremental evaluation period to determine whether the branch is to be bult. The second incremental evaluation period is defined to extend from the second time instance to a third time instance at which the branch is to be built. In an implementation of this example, evaluation of the security over the second incremental evaluation period includes determining whether the branch complies with the security policy throughout the second incremental evaluation period. In accordance with this implementation, the branch complying with the security policy throughout the second incremental evaluation period indicates that the branch is to be built. In further accordance with this implementation, the branch failing to comply with the security policy during the first incremental evaluation period indicates that the branch is not to be built.

By incrementally evaluating the security of the branch over time, operations that otherwise would have been performed to re-determine the security of the branch over the first incremental evaluation period when the security of the branch over the second incremental evaluation period is determined need not be performed.

The example techniques may automate determining whether security of branches of a main codebase of software is compromised (e.g., fail to comply with a security policy), ensuring that branch(es) that are incorporated into the main codebase comply with the security policy from creation of the branch(es) to deployment of the branch(es), and/or deploying the branch(es). By reducing the amount of time and/or resources that is consumed by a computing system to perform any of the above-referenced operations, the efficiency of the computing system may be increased. By reducing the amount of time that is consumed to perform any of the above-referenced operations, the example techniques may increase a user experience and/or efficiency of a security professional who manages security of the main codebase, a computing system on which the branch(es) of the main codebase execute, and/or a resource (e.g., data or code) that one or more of the branch(es) are configured to access. The example techniques may reduce a number of tasks that are manually performed by the security professional by automating determining whether the security of the branches of the main codebase are compromised, ensuring that the branch(es) that are incorporated into the main codebase comply with the security policy from the creation of the branch(es) to the deployment of the branch(es), and/or deploying the branch(es).

The example techniques may increase a user experience and/or efficiency of an end user who accesses (e.g., utilizes) the software and/or a computing system that is used by the end user to access the software. The user experience and/or the efficiency of the security professional and/or the end user may be increased in other ways, as well. For example, the user experience and/or the efficiency may be increased through a more accurate, precise, and/or reliable determination whether the branches of the main codebase are compromised (e.g., fail to comply with a security policy) and/or a more accurate, precise, and/or reliable determination whether any one or more of the branches remain uncompromised (e.g., continuously comply with the security policy) from their creation until their deployment.

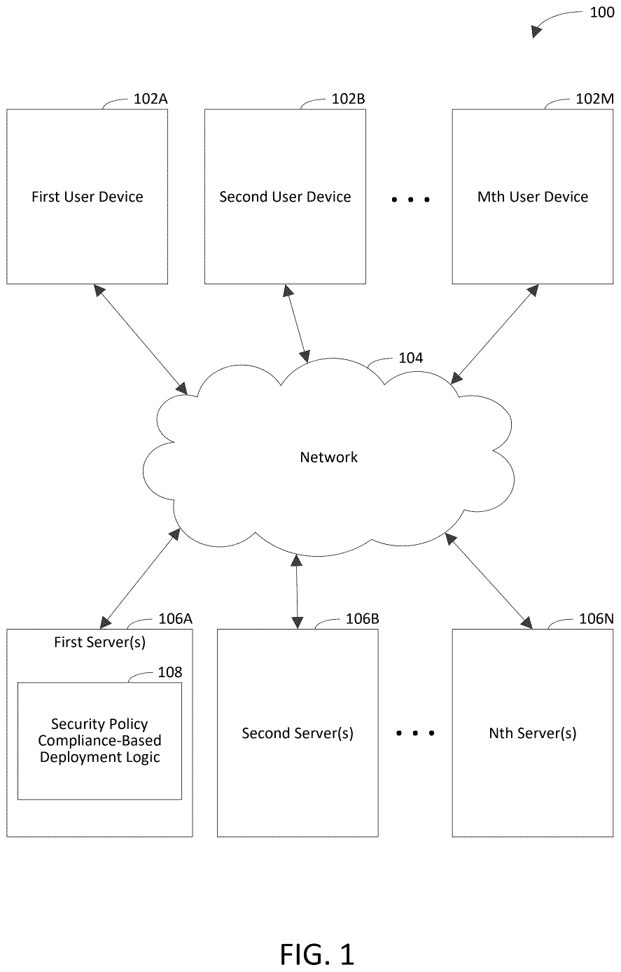

FIG. 1 is a block diagram of an example security policy compliance-based deployment system 100 in accordance with an embodiment. Generally speaking, the security policy compliance-based deployment system 100 operates to provide information to users in response to requests (e.g., hypertext transfer protocol (HTTP) requests) that are received from the users. The information may include documents (Web pages, images, audio files, video files, etc.), output of executables, and/or any other suitable type of information. In accordance with example embodiments described herein, the security policy compliance-based deployment system 100 deploys branch(es) of a main codebase based on compliance of the branch(es) with a security policy since creation of the branch(es). Detail regarding techniques for deploying branch(es) of a main codebase based on compliance of the branch(es) with a security policy since creation of the branch(es) is provided in the following discussion.

As shown in FIG. 1, the security policy compliance-based deployment system 100 includes a plurality of user devices 102A-102M, a network 104, and a plurality of servers 106A-106N. Communication among the user devices 102A-102M and the servers 106A-106N is carried out over the network 104 using well-known network communication protocols. The network 104 may be a wide-area network (e.g., the Internet), a local area network (LAN), another type of network, or a combination thereof.

The user devices 102A-102M are computing systems that are capable of communicating with servers 106A-106N. A computing system is a system that includes at least a portion of a processor system such that the portion of the processor system includes at least one processor that is capable of manipulating data in accordance with a set of instructions. A processor system includes one or more processors, which may be on a same (e.g., single) device or distributed among multiple (e.g., separate) devices. For instance, a computing system may be a computer, a personal digital assistant, etc. The user devices 102A-102M are configured to provide requests to the servers 106A-106N for requesting information stored on (or otherwise accessible via) the servers 106A-106N. For instance, a user may initiate a request for executing a computer program (e.g., an application) using a client (e.g., a Web browser, Web crawler, or other type of client) deployed on a user device 102 that is owned by or otherwise accessible to the user. In accordance with some example embodiments, the user devices 102A-102M are capable of accessing domains (e.g., Web sites) hosted by the servers 104A-104N, so that the user devices 102A-102M may access information that is available via the domains. Such domain may include Web pages, which may be provided as hypertext markup language (HTML) documents and objects (e.g., files) that are linked therein, for example.

Each of the user devices 102A-102M may include any client-enabled system or device, including but not limited to a desktop computer, a laptop computer, a tablet computer, a wearable computer such as a smart watch or a head-mounted computer, a personal digital assistant, a cellular telephone, an Internet of things (IoT) device, or the like. It will be recognized that any one or more of the user devices 102A-102M may communicate with any one or more of the servers 106A-106N.

The servers 106A-106N are computing systems that are capable of communicating with the user devices 102A-102M. The servers 106A-106N are configured to execute computer programs that provide information to users in response to receiving requests from the users. For example, the information may include documents (Web pages, images, audio files, video files, etc.), output of executables, or any other suitable type of information. In accordance with some example embodiments, the servers 106A-106N are configured to host respective Web sites, so that the Web sites are accessible to users of the security policy compliance-based deployment system 100.

One example type of computer program that may be executed by one or more of the servers 106A-106N is a developer tool. A developer tool is a computer program that performs diagnostic operations (e.g., identifying source of problem, debugging, profiling, controlling, etc.) with respect to program code. Examples of a developer tool include an integrated development environment (IDE) and a web development platform. Examples of an IDE include a Microsoft Visual Studio® IDE, developed and distributed by Microsoft Corporation; an AppCode® IDE, a PhpStorm® IDE, a Rider® IDE, a WebStorm® IDE, etc., developed and distributed by JetBrains s.r.o. ; a JDeveloper® IDE, developed and distributed by Oracle International Corporation; a NetBeans® IDE, developed and distributed by Sun Microsystems, Inc. ; an Eclipse™ IDE, developed and distributed by Eclipse Foundation; and an Android Studio™ IDE, developed and distributed by Google LLC and JetBrains s.r.o. Examples of a web development platform include a Windows Azure® platform, developed and distributed by Microsoft Corporation; an Amazon Web Services® platform, developed and distributed by Amazon. com, Inc. ; a Google App Engine® platform, developed and distributed by Google LLC; a VMWare® platform, developed and distributed by VMWare, Inc. ; and a Force. com® platform, developed and distributed by Salesforce, Inc. It will be recognized that the example techniques described herein may be implemented using a developer tool.

Another example type of a computer program that may be executed by one or more of the servers 106A-106N is a computer security program. A computer security program is a computer program that provides security with regard to information and/or communications associated with a computing system. For instance, the information associated with the computing system may include information stored on the computing system and/or information accessed (e.g., read) by the computing system. The communications associated with the computing system may include communications received by the computing system and/or communications provided (e.g., transmitted) by the computing system. An example of a communication is an electronic message. Examples of a computer security program include Bitdefender® security program, developed and distributed by Bitdefender IPR Management Ltd. ; Norton® security program, developed and distributed by Gen Digital Inc. ; Avast® security program, developed and distributed by Avast Software S.R.O. ; McAfee® security program, developed and distributed by McAfee, LLC; and Microsoft Defender® security program, developed and distributed by Microsoft Corporation. It will be recognized that the example techniques described herein may be implemented using a computer security program. For instance, a software product (e.g., a subscription service, a non-subscription service, or a combination thereof) may include the computer security program, and the software product may be configured to perform the example techniques, though the scope of the example embodiments is not limited in this respect.

The computer security program may be a cloud native application protection platform (CNAPP). A CNAPP is an all-in-one platform that unifies security and compliance capabilities to prevent, detect, and respond to cloud security threats. A CNAPP integrates multiple cloud security solutions, which traditionally have been siloed, into a common (e.g., single) user interface. The cloud security solutions may include cloud security posture management (CSPM), multipipeline development and operations (DevOps) security, a cloud workload protection platform (CWPP), cloud infrastructure entitlement management (CIEM), and cloud service network security (CSNS). CSPM provides a connected, prioritized view of potential vulnerabilities and misconfigurations across multi-cloud and hybrid environments. The CSPM continuously assesses overall security posture of a system and provides automated alerts and recommendations about critical issues that could expose the system to data breaches. The CSPM may include automated compliance management and remediation tools to identify and remedy compliance deficiencies. Multipipeline DevOps security provides a central console that enables management of DevOps security across multiple (e.g., all) pipelines. For instance, the multipipeline DevOps security may be used to reduce cloud misconfigurations and to scan new code to keep vulnerabilities therein from reaching a production environment. The multipipeline DevOps security may include infrastructure-as-code scanning tools that analyze configuration files from the earliest stages of development to confirm that new configuration files are compliant with security policies. A CWPP provides real-time detection and response to threats based on up-to-date information regarding multi-cloud workloads (e.g., virtual machines, containers, Kubernetes® pods and/or clusters, databases, storage accounts, network layers, and app services). The CWPP may enable a quick investigation into threats and reduce the attack surface of a system. CIEM centralizes permissions management across a cloud and hybrid footprint, which inhibits (e.g., prevents) accidental or malicious misuse of permissions. CSNS complements the CWPP by protecting cloud infrastructure in real time. The CSNS may include any of a variety of security tools, including but not limited to distributed denial-of-service protection, web application firewalls, transport layer security examination, and load balancing.

A computer security program may be incorporated into a cloud computing program (a.k.a. a cloud service). A cloud computing program is a computer program that provides hosted service(s) via a network (e.g., network 104). For instance, the hosted service(s) may be hosted by any one or more of the servers 106A-106N. The cloud computing program may enable users (e.g., at any of the user systems 102A-102M) to access shared resources that are stored on or are otherwise accessible to the server(s) via the network.

The cloud computing program may provide hosted service(s) according to any of a variety of service models, including but not limited to Backend as a Service (BaaS), Software as a Service (SaaS), Platform as a Service (PaaS), and Infrastructure as a Service (IaaS). BaaS enables applications (e.g., software programs) to use a BaaS provider's backend services (e.g., push notifications, integration with social networks, and cloud storage) running on a cloud infrastructure. SaaS enables a user to use a SaaS provider's applications running on a cloud infrastructure. PaaS enables a user to develop and run applications using a PaaS provider's application development environment (e.g., operating system, programming-language execution environment, database) on a cloud infrastructure. IaaS enables a user to use an IaaS provider's computer infrastructure (e.g., to support an enterprise). For example, IaaS may provide to the user virtualized computing resources that utilize the IaaS provider's physical computer resources.

Examples of a cloud computing program include but are not limited to a Google Cloud® program developed and distributed by Google Inc. ; an Oracle Cloud® program developed and distributed by Oracle Corporation; an Amazon Web Services® program developed and distributed by Amazon. com, Inc. ; a Salesforce® program developed and distributed by Salesforce. com, Inc. ; an AppSource® program developed and distributed by Microsoft Corporation; an Azure® program developed and distributed by Microsoft Corporation; a GoDaddy® program developed and distributed by GoDaddy. com LLC; and a Rackspace® program developed and distributed by Rackspace US, Inc. It will be recognized that the example techniques described herein may be implemented using a cloud computing program. For instance, a software product (e.g., a subscription service, a non-subscription service, or a combination thereof) may include the cloud computing program, and the software product may be configured to perform the example techniques, though the scope of the example embodiments is not limited in this respect.

The first server(s) 106A are shown to include security policy compliance-based deployment logic 108 for illustrative purposes. The security policy compliance-based deployment logic 108 is configured to deploy branch(es) of a main codebase based on compliance of the branch(es) with a security policy since creation of the branch(es). In a first example implementation, as a result of a first branch of a main codebase undergoing an official build, the security policy compliance-based deployment logic 108 stores the first branch in a designated store. As a result of verifying that a second branch of the main codebase has complied with a security policy since creation of the second branch, the security policy compliance-based deployment logic 108 stores the second branch in the designated store. The security policy compliance-based deployment logic 108 determines that a deployment criterion is satisfied by verifying that the first branch and the second branch are stored in the designated store and that the first branch and the second branch have complied with the security policy since being stored in the designated store. As a result of the deployment criterion being satisfied, the security policy compliance-based deployment logic 108 generates a first deployable code branch and a second deployable code branch by building the first branch and the second branch, respectively. As a result of a request to deploy a build of the main codebase being received, the security policy compliance-based deployment logic 108 deploys the first deployable code branch and the second deployable code branch.

In a second example implementation, the security policy compliance-based deployment logic 108 stores a first branch of a main codebase in a designated store, instead of storing a second branch of the main codebase in the designated store, as a result of the first branch continuously complying with a security policy since creation of the first branch and the second branch failing to continuously comply with the security policy since creation of the second branch. As a result of the first branch of the main codebase being stored in the designated store and the first branch continuing to comply with the security policy since the first branch was stored in the designated store, the security policy compliance-based deployment logic 108 converts the first branch into a deployable code branch by building the first branch. In response to a request to deploy a build of the main codebase, the security policy compliance-based deployment logic 108 deploys the deployable code branch.

In a third example implementation, at a first time instance, the security policy compliance-based deployment logic 108 determines whether first, second, and third branches of a main codebase comply with a security policy throughout respective first, second, and third time periods that begin at creation of the first, second, and third branches and that end at the first time instance. The security policy compliance-based deployment logic 108 stores the first and second branches of the main codebase in a designated store, instead of storing the third branch in the designated store, as a result of the first and second branches complying with the security policy throughout the respective first and second time periods and the third branch failing to comply with the security policy during the respective third time period. At a second time instance, the security policy compliance-based deployment logic 108 converts the first branch into a deployable code branch by building the first branch, instead of building the second branch, as a result of the first branch being stored in the designated store and the first branch complying with the security policy throughout a fourth time period and the second branch failing to comply with the security policy during the fourth time period. The fourth time period begins at the first time instance and ends at the second time instance. As a result of a request to deploy a build of the main codebase being received, the security policy compliance-based deployment logic 108 deploys the deployable code branch.

The security policy compliance-based deployment logic 108 may be implemented in various ways to deploy branch(es) of a main codebase based on compliance of the branch(es) with a security policy since creation of the branch(es), including being implemented in hardware, software, firmware, or any combination thereof. For example, the security policy compliance-based deployment logic 108 may be implemented as computer program code configured to be executed in one or more processors. In another example, at least a portion of the security policy compliance-based deployment logic 108 may be implemented as hardware logic/electrical circuitry. For instance, at least a portion of the security policy compliance-based deployment logic 108 may be implemented in a field-programmable gate array (FPGA), an application-specific integrated circuit (ASIC), an application-specific standard product (ASSP), a system-on-a-chip system (SoC), a complex programmable logic device (CPLD), etc. Each SoC may include an integrated circuit chip that includes one or more of a processor (a microcontroller, microprocessor, digital signal processor (DSP), etc.), memory, one or more communication interfaces, and/or further circuits and/or embedded firmware to perform its functions.

It will be recognized that the security policy compliance-based deployment logic 108 may be (or may be included in) a developer tool, a computer security program, and/or a cloud computing program, though the scope of the example embodiments is not limited in this respect.

The security policy compliance-based deployment logic 108 is shown to be incorporated in the first server(s) 106A for illustrative purposes and is not intended to be limiting. It will be recognized that the security policy compliance-based deployment logic 108 (or any portion(s) thereof) may be incorporated in any one or more of the servers 106A-106N, any one or more of the user devices 102A-102M, or any combination thereof. For example, client-side aspects of the security policy compliance-based deployment logic 108 may be incorporated in one or more of the user devices 102A-102M, and server-side aspects of security policy compliance-based deployment logic 108 may be incorporated in one or more of the servers 106A-106N.

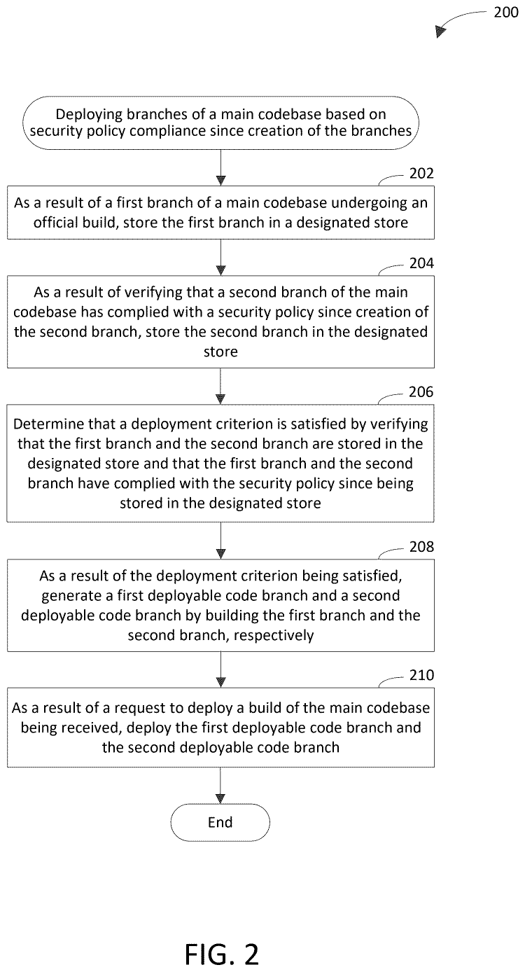

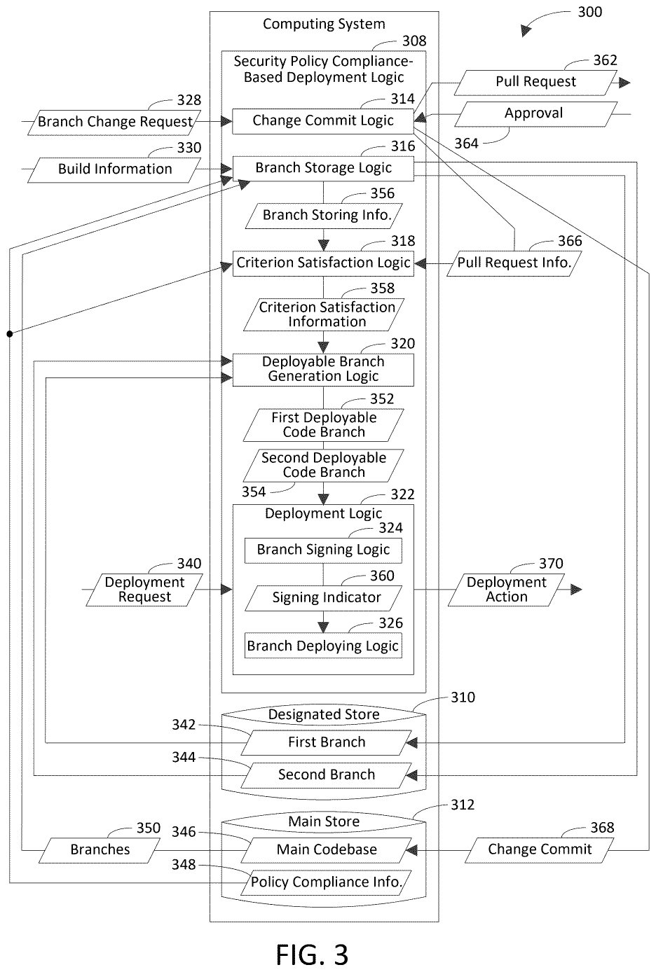

FIG. 2 depicts a flowchart 200 of an example method for deploying branches of a main codebase based on security policy compliance since creation of the branches in accordance with an embodiment. Flowchart 200 may be performed by the first server(s) 106A shown in FIG. 1, for example. For illustrative purposes, flowchart 200 is described with respect to a computing system 300 shown in FIG. 3, which is an example implementation of the first server(s) 106A. As shown in FIG. 3, the computing system 300 includes security policy compliance-based deployment logic 308, a designated store 310, and a main store 312. The security policy compliance-based deployment logic 308 includes change commit logic 314, branch storage logic 316, criterion satisfaction logic 318, deployable branch generation logic 320, and deployment logic 322. The deployment logic 322 includes branch signing logic 324 and branch deploying logic 326. Each of the designated store 310 and the main store 312 may be any suitable type of store. One type of store is a database. For instance, each of the designated store 310 and the main store 312 may be a relational database, an entity-relationship database, an object database, an object relational database, an extensible markup language (XML) database, etc. The designated store 310 is shown to store a first branch 342 of a main codebase 346 and a second branch 344 of the main codebase 346 for non-limiting, illustrative purposes. The main store 312 is shown to store the main codebase 346 and policy compliance information 348 for non-limiting, illustrative purposes. Further structural and operational embodiments will be apparent to persons skilled in the relevant art(s) based on the discussion regarding flowchart 200.

As shown in FIG. 2, the method of flowchart 200 begins at step 202. In step 202, as a result of a first branch of a main codebase (e.g., source code) undergoing an official build, storing the first branch in a designated store. An official build of a branch includes (e.g., comprises) compiling code in the branch to create an artifact (e.g., executable code or a library) and releasing the branch to end users of the branch. A designated store is a store that is configured to store branch(es) of a main codebase. The designated store may be a cache, a persistent storage, or a combination thereof. A cache is a store in which information stored therein remains available after a system that includes the store is restarted. A persistent storage is a store in which information stored therein does not remain available after a system that includes the store is restarted. In an example implementation, as a result of the first branch 342 of the main codebase 346 undergoing an official build, the branch storage logic 316 stores the first branch 342 in the designated store 310. In an aspect, build information 330 indicates (e.g., specifies) which of a plurality of branches 350 have undergone an official build. In accordance with this aspect, the branch storage logic 316 analyzes the build information 330 to determine that the first branch 342, which is included in the branches 350, has undergone an official build. In further accordance with this aspect, the branch storage logic 316 stores the first branch 342 in the designated store 310 based on (e.g., based at least on) the build information 330 indicating that the first branch 342 has undergone an official build. In an example of this aspect, the branch storage logic 316 retrieves the branches 350 of the main codebase 346 from the main store 312. In accordance with this example, the branch storage logic 316 cross-references the branches 350 with the build information 330 to determine which of the branches 350 are indicated by the build information 330. In further accordance with this example, the first branch 342 being indicated by the build information 330 indicates that the first branch 342 has undergone an official build.

At step 204, as a result of verifying that a second branch of the main codebase has complied with a security policy since creation of the second branch, storing the second branch in the designated store. In an aspect, the second branch is created in response to a creation instruction that is received via a command-line interface. The creation instruction indicates that the second branch is to be created. A command-line interface is an interface that enables a user to interact with a computing system by providing textual input. The textual input may be configured as line(s) of text, which are referred to as command line(s). In another aspect, the second branch has not undergone an official build at a time instance at which the second branch is stored in the designated store.

In an example implementation, as a result of verifying that the second branch 344 of the main codebase 346 has complied with the security policy since creation of the second branch 344, the branch storage logic 316 stores the second branch 344 in the designated store 310. In an aspect, the policy compliance information 348 indicates whether the branches 350 of the main codebase 346 have complied with the security policy since their creation. In an example, the policy compliance information 348 is an up-to-date (e.g., currently accurate) record of whether each of the branches 350 of the main codebase 346 has complied with the security policy over an entirety of a history (e.g., a lifetime) of the respective branch. In accordance with this aspect, the branch storage logic 316 analyzes the policy compliance information 348 to determine whether the second branch 344 has complied with the security policy since creation of the second branch 344. In a value-assigning example, each of the branches 350 of the main codebase 346 that has complied with the security policy since creation of the respective branch is assigned a first value (e.g., a first binary value, such as “1”), and each branch that has failed to comply with the security policy since creation of the respective branch is assigned a second value (e.g., a second binary value, such as “0”). The first value and the second value are different. In accordance with the value-assigning example, the branch storage logic 316 verifies that the second branch 344 has complied with the security policy since creation of the second branch 344 based on the policy compliance information 348 indicating that the second branch 344 is assigned the first value. The branch storage logic 316 generates branch storing information 356, which indicates that the first branch 342 and the second branch 344 are stored in the designated store 310.

At step 206, a determination is made that a deployment criterion is satisfied by verifying that the first branch and the second branch are stored in the designated store and that the first branch and the second branch have complied with the security policy since being stored in the designated store. A deployment criterion is a condition that is to be satisfied (e.g., must be satisfied) prior to deployment of code (e.g., software or firmware). For instance, satisfaction of the deployment criterion may ensure that the code is stable, functional, and ready for use by end user(s). In an aspect, the determination is made at step 206 as a result of the first branch and the second branch complying with the security policy since being stored in the designated store until a time instance at which a request to deploy a build of the main codebase is received. In an example implementation, the criterion satisfaction logic 318 determines that the deployment criterion is satisfied by verifying that the first branch 342 and the second branch 344 are stored in the designated store 310 and that the first branch 342 and the second branch 344 have complied with the security policy since being stored in the designated store 310. In an aspect, the criterion satisfaction logic 318 verifies that the first branch 342 and the second branch 344 are stored in the designated store 310 as a result of the branch storing information 356 indicating that the first branch 342 and the second branch 344 are stored in the designated store 310. In another aspect, the criterion satisfaction logic 318 verifies that the first branch 342 and the second branch 344 have complied with the security policy since being stored in the designated store 310 as a result of the policy compliance information 348 indicating that the first branch 342 and the second branch 344 have complied with the security policy since being stored in the designated store 310. In an example, the policy compliance information 348 is updated (e.g., iteratively, continuously, or periodically updated) to indicate whether branch(es), which had complied with the security policy since creation of the branch(es) until a time instance associated with a last update, continue to comply with the security instance since the last update. In accordance with this example, the criterion satisfaction logic 318 verifies that the first branch 342 and the second branch 344 have complied with the security policy since being stored in the designated store 310 based on updates to the policy compliance information 348 since the first branch 342 and the second branch 344 were stored in the designated store 310 indicating that the first branch 342 and the second branch 344 continue to comply with the security policy. The criterion satisfaction logic 318 generates criterion satisfaction information 358 to indicate that the deployment criterion is satisfied.

At step 208, as a result of the deployment criterion being satisfied, generating a first deployable code branch and a second deployable code branch by building the first branch and the second branch, respectively. In an example implementation, as a result of the deployment criterion being satisfied, the deployable branch generation logic 320 generates a first deployable code branch 352 and a second deployable code branch 354 by building the first branch 342 and the second branch 344, respectively. In an aspect, the deployable branch generation logic 320 generates the first deployable code branch 352 and the second deployable code branch 354 as a result of the criterion satisfaction information 358 indicating that the deployment criterion is satisfied.

At step 210, as a result of a request to deploy a build of the main codebase being received, the first deployable code branch and the second deployable code branch are deployed. In an aspect, step 210 comprises triggering execution of an instruction, which causes the first deployable code branch and the second deployable code branch to be deployed. In an example implementation, as a result of a deployment request 340 being received, the deployment logic 322 performs a deployment action 370, which includes deploying the first deployable code branch 352 and the second deployable code branch 354. The deployment request 340 requests deployment of a build of the main codebase 346. In an aspect, the deployment action 370 includes triggering execution of an instruction, which causes the first deployable code branch 352 and the second deployable code branch 354 to be deployed.

In some example embodiments, one or more steps 202, 204, 206, 208, and/or 210 of flowchart 200 may not be performed. Moreover, steps in addition to or in lieu of steps 202, 204, 206, 208, and/or 210 may be performed. For instance, in an example certificate embodiment, the method of flowchart 200 further comprises signing the first deployable code branch and the second deployable code branch with a production certificate. In an aspect, signing the first deployable code branch and the second deployable code branch with the production certificate attests to trust of the first deployable code branch and the second deployable code branch. In an example implementation, the branch signing logic 324 signs the first deployable code branch 352 and the second deployable code branch 354 with the production certificate. The branch signing logic 324 generates a signing indicator 360, which indicates that the first deployable code branch 352 and the second deployable code branch 354 are signed with the production certificate. In an aspect, the signing indicator 360 includes the production certificate. In accordance with the certificate embodiment, step 210 comprises, as the result of the request to deploy the build of the main codebase being received and the first deployable code branch and the second deployable code branch being signed with the production certificate, deploying the first deployable code branch and the second deployable code branch. In an example implementation, the branch deploying logic 326 deploys the first deployable code branch 352 and the second deployable code branch 354 as a result of the deployment request 340 being received and the signing indicator 360 indicating that the first deployable code branch 352 and the second deployable code branch 354 are signed with the production certificate.

In an example pull request embodiment, the security policy specifies that merging an arbitrary change that is comprised in an arbitrary branch of the main codebase (e.g., main codebase 346) into the main codebase is conditioned on satisfaction of a prerequisite. The prerequisite comprises creation of a pull request (e.g., pull request 362), which requests merging the arbitrary change into the main codebase, and further comprises approval (e.g., approval 364) of the pull request. In accordance with this embodiment, the method of flowchart 200 further comprises committing a change in a specified branch of the main codebase. Committing the change comprises merging the change into the main codebase by performing at least first and second operations in satisfaction of the prerequisite. The first operation comprises creating a first pull request, which requests a merge of the change into the main codebase. The second operation comprises receiving approval of the first pull request as a result of the change complying with the security policy. In further accordance with this embodiment, the specified branch is the first branch or the second branch.

In an example implementation of the pull request embodiment, the change commit logic 314 performs a change commit 368, which commits a change in a specified branch of the main codebase 346. The specified branch is the first branch 342 or the second branch 344, both of which are comprised in the branches 350. Performing the change commit 368 includes merging the change into the main codebase 346 by performing at least first and second operations in satisfaction of the prerequisite. The first operation includes creating the pull request 362, which requests a merge of the change into the main codebase 346. The second operation includes receiving approval 364 of the pull request 362 as a result of the change complying with the security policy. In an aspect, the change commit logic 314 generates pull request information 366 as a result of performing the first and second operations. The pull request information 366 indicates that the pull request 362 is created and that the approval 364 of the pull request 362 is received.

In an aspect of the pull request embodiment, the second branch is stored in the designated store at step 204 as a result of the first pull request being created and the approval of the first pull request being received. In an example implementation of this aspect, the branch storage logic 316 stores the second branch 344 in the designated store 310 as a result of the change commit logic 314 creating the pull request 362 and the change commit logic 314 receiving the approval 364 of the pull request 362. In an aspect, the branch storage logic 316 stores the second branch 344 in the designated store 310 based on receipt of the pull request information 366. In an example of this aspect, the branch storage logic 316 stores the second branch 344 in the designated store 310 as a result of the pull request information 366 indicating that the pull request 362 is created and that the approval 362 of the pull request 362 is received.

In another aspect of the pull request embodiment, determining that the deployment criterion is satisfied at step 206 comprises determining that the first pull request is created during a time period that temporally follows storage of the specified branch in the designated store. In accordance with this aspect, determining that the deployment criterion is satisfied at step 206 further comprises determining that the approval of the first pull request is received. In further accordance with this aspect, generating the first deployable code branch and the second deployable code branch at step 208 comprises building the specified branch as a result of the first pull request being created during the time period that temporally follows the storage of the specified branch in the designated store and the approval of the first pull request being received. In an aspect, the pull request information 366 indicates a time instance at which the pull request 362 is created. In accordance with this aspect, the criterion satisfaction logic 318 determines that the pull request 362 is created during the time period that temporally follows the storage of the specified branch in the designated store 310 by determining that the time instance indicated by the pull request information 366 is included in the time period that temporally follows the storage of the specified branch in the designated store 310.

In yet another aspect of the pull request embodiment, the approval of the first pull request is received as a result of the change being reviewed by a number of reviewers that is greater than or equal to a threshold number. The threshold number is greater than or equal to two. For instance, the threshold number may be any positive integer that is greater than or equal to two. In an aspect, the security policy provides a limitation with regard to the reviewers. In accordance with this aspect, the security policy may limit the circumstances in which any one or more entities are allowed to be included among the reviewers. In a first example, the security policy disallows an entity that created the change from being included among the reviewers. In second example, the security policy includes a limitation that is triggered by the change being a most recent change that is requested to be merged into the main codebase. In accordance with the second example, the limitation disallows an entity that created the change from being included among the reviewers. In another aspect, the security policy enables approval of the first pull request so long as a proportion of the reviewers that indicate approval of the first pull request is greater than or equal to a proportion threshold.

In still another aspect of the pull request embodiment, the approval of the first pull request is received as a result of the change being reviewed by a designated reviewer (e.g., a required reviewer) that is identified by the security policy. In an example, the security policy specifies an identifier (e.g., a name) associated with the designated reviewer. For instance, the identifier may uniquely identify the designated reviewer. In another example, the approval of the first pull request is received as a result of the change being reviewed by a plurality of designated reviewers (e.g., required reviewers) that are identified by the security policy. For instance, the security policy may specify an identifier (e.g., a name) for each designated user in the plurality of designated reviewers. Each identifier may uniquely identify the respective designated reviewer.

In another aspect of the pull request embodiment, the approval of the first pull request is received as a result of the first pull request being created at a designated (e.g., required) computing system, which is identified (e.g., uniquely identified) by the security policy. In an example, the security policy specifies an Internet Protocol (IP) address of the designated computing system.

In yet another aspect of the pull request embodiment, the approval of the first pull request is received further as a result of the security policy remaining unchanged since the creation of the second branch of the main codebase.

In still another aspect of the pull request embodiment, the approval of the first pull request is received further as a result of the security policy remaining enforced since the creation of the second branch of the main codebase. In an example, the security policy remaining enforced since the creation of the second branch of the main codebase requires that the security policy has not been turned off (e.g., switched from an on state to an off state) and then turned back on (e.g., switched from the off state back to the on state) since the creation of the second branch.

It will be recognized that the computing system 300 may not include one or more of the security policy compliance-based deployment logic 308, the designated store 310, the main store 312, the change commit logic 314, the branch storage logic 316, the criterion satisfaction logic 318, the deployable branch generation logic 320, the deployment logic 322, the branch signing logic 324, and/or the branch deploying logic 326. Furthermore, the computing system 300 may include components in addition to or in lieu of the security policy compliance-based deployment logic 308, the designated store 310, the main store 312, the change commit logic 314, the branch storage logic 316, the criterion satisfaction logic 318, the deployable branch generation logic 320, the deployment logic 322, the branch signing logic 324, and/or the branch deploying logic 326.

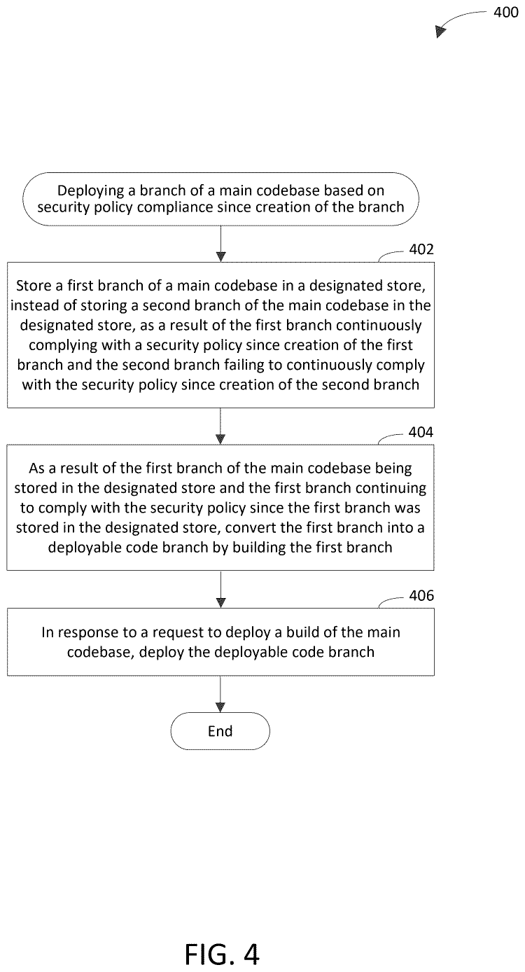

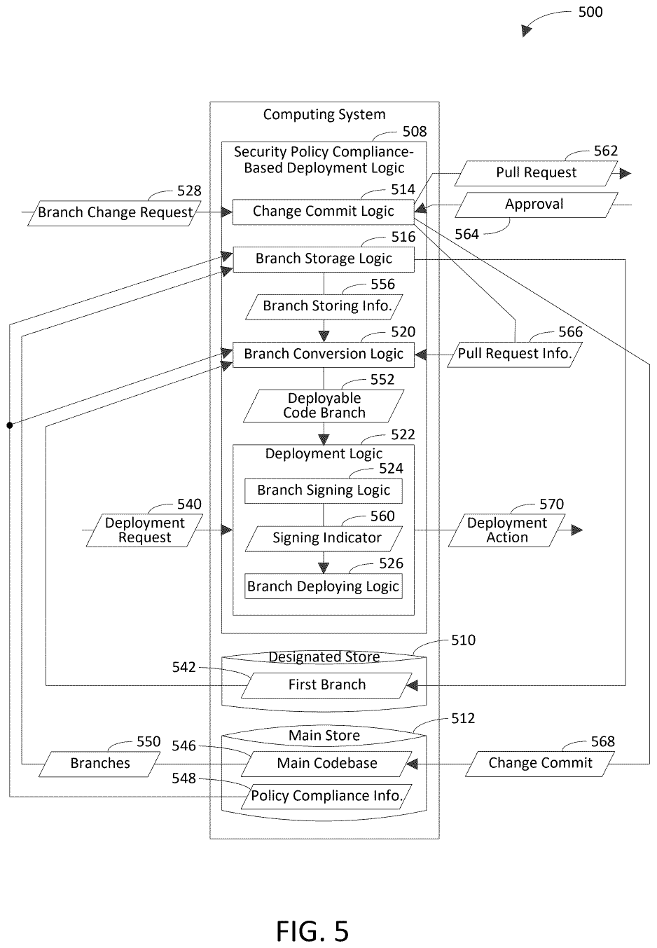

FIG. 4 depicts a flowchart 400 of an example method for deploying a branch of a main codebase based on security policy compliance since creation of the branch in accordance with an embodiment. Flowchart 400 may be performed by the first server(s) 106A shown in FIG. 1, for example. For illustrative purposes, flowchart 400 is described with respect to a computing system 500 shown in FIG. 5, which is an example implementation of the first server(s) 106A. As shown in FIG. 5, the computing system 500 includes security policy compliance-based deployment logic 508, a designated store 510, and a main store 512. The security policy compliance-based deployment logic 508 includes change commit logic 514, branch storage logic 516, branch conversion logic 520, and deployment logic 522. The deployment logic 522 includes branch signing logic 524 and branch deploying logic 526. Each of the designated store 510 and the main store 512 may be any suitable type of store. For instance, each of the designated store 510 and the main store 512 may be a relational database, an entity-relationship database, an object database, an object relational database, an extensible markup language (XML) database, etc. The designated store 510 is shown to store a first branch 542 of a main codebase 546 for non-limiting, illustrative purposes. The main store 512 is shown to store the main codebase 546 and policy compliance information 548 for non-limiting, illustrative purposes. Further structural and operational embodiments will be apparent to persons skilled in the relevant art(s) based on the discussion regarding flowchart 400.

As shown in FIG. 4, the method of flowchart 400 begins at step 402. In step 402, a first branch of a main codebase is stored in a designated store, instead of (e.g., in absence of or without) a second branch of the main codebase being stored in the designated store, as a result of the first branch continuously complying with a security policy since creation of the first branch and the second branch failing to continuously comply with the security policy since creation of the second branch. In an example implementation, the branch storing logic 516 stores the first branch 542 of the main codebase 546 in the designated store, 510 instead of storing a second branch of the main codebase 546 in the designated store 510, as a result of the first branch 542 continuously complying with the security policy since creation of the first branch 542 and the second branch failing to continuously comply with the security policy since creation of the second branch. In an aspect, the first branch 542 and the second branch are included in a plurality of branches 550 of the main codebase 546. In another aspect, the branch storage logic 516 stores the first branch 542 and not the second branch in the designated store 510 based on (e.g., based at least on) the policy compliance information 548 indicating that the first branch 542 continuously complies with the security policy since creation of the first branch 542 and further indicating that the second branch does not continuously comply with the security policy since the creation of the second branch. In an example of this implementation, the branch storage logic 516 retrieves the branches 550 of the main codebase 546 from the main store 512. In accordance with this example, the branch storage logic 516 cross-references the branches 550 with the policy compliance information 548 to determine that the first branch 542 continuously complies with the security policy since creation of the first branch 742 and further to determine that the second branch does not continuously comply with the security policy since creation of the second branch. The branch storage logic 516 generates branch storing information 556, which indicates that the first branch 542 is stored in the designated store 510. In an example, the branch storing information 556 further indicates that the second branch is not stored in the designated store 510.

At step 404, as a result of the first branch of the main codebase being stored in the designated store and the first branch continuing to comply with the security policy since the first branch was stored in the designated store, the first branch is converted into a deployable code branch by building the first branch. In an aspect, the first branch is converted into the deployable code branch at step 404 instead of converting the second branch into a deployable code branch. In an example of this aspect, the first branch is built instead of building the second code branch. In another aspect, step 404 is performed as a result of the first branch of the main codebase being stored in the designated store and the first branch continuing to comply with the security policy since the first branch was stored in the designated store until a request to deploy a build of the main codebase is received. In an example implementation, as a result of the first branch 542 of the main codebase 546 being stored in the designated store 510 and the first branch 542 continuing to comply with the security policy since the first branch 542 was stored in the designated store 510, the branch conversion logic 520 converts the first branch 542 into a deployable code branch 552 by building the first branch 542. In an example, the branch conversion logic 520 converts the first branch 542 into the deployable code branch 552 based on the branch storing information 556 indicating that the first branch 542 is stored in the designated store 510 and the policy compliance information 548 indicating that the first branch 542 continues to comply with the security policy since the first branch 542 was stored in the designated store 510.

In an example of this implementation, policy compliance information 548 associates the first branch 542 with a first value (e.g., a first binary value, such as “1”), rather than a second value (e.g., a second binary value, such as “0”), to indicate that the first branch 542 continues to comply with the security policy since the first branch 542 was stored in the designated store 510. The first value and the second value are different. In accordance with this example, a branch being associated with the first value indicates that the branch has continuously complied with the security policy since creation of the branch (e.g., including since the branch was stored in the designated store 510, if the branch was stored in the designated store 510). In further accordance with this example, the branch being associated with the second value indicates that the branch has not continuously complied with the security policy since the creation of the branch. In further accordance with this example, the branch conversion logic 520 determines that the first branch 542 continues to comply with the security policy since the first branch 542 was stored in the designated store 510 based on the policy compliance information 548 associating the first branch 542 with the first value (e.g., rather than the second value).

In another example of this implementation, the policy compliance information 548 is updated (e.g., iteratively, continuously, or periodically updated) to indicate whether the first branch 542, which had complied with the security policy since creation of the first branch 542 until a time instance associated with a last update, continues to comply with the security instance since the last update. In accordance with this example, the branch conversion logic 520 determines that the first branch 542 continues to comply with the security policy since the first branch 542 was stored in the designated store 510 based on updates to the policy compliance information 548 since the first branch 542 was stored in the designated store 510 indicating that the first branch 542 continues to comply with the security policy.

At step 406, in response to a request to deploy a build of the main codebase, the deployable code branch is deployed. In an aspect, step 406 comprises triggering execution of an instruction, which causes the deployable code branch to be deployed. In an example implementation, in response to a deployment request 540, the deployment logic 522 performs a deployment action 570, which includes deploying the deployable code branch 552. In accordance with this implementation, the deployment request 540 requests deployment of a build of the main codebase 546. In an example, the deployment logic 522 performs the deployment action 570 as a result of the first branch 542 being stored in the designated store 510 and the first branch 542 continuing to comply with the security policy since the first branch 542 was stored in the designated store 510 at least until the deployment action 570 is performed. In an aspect, the deployment action 570 includes triggering execution of an instruction, which causes the deployable code branch 352 to be deployed.

In some example embodiments, one or more steps 402, 404, and/or 406 of flowchart 400 may not be performed. Moreover, steps in addition to or in lieu of steps 402, 404, and/or 406 may be performed. For instance, in an example certificate embodiment, the method of flowchart 400 further comprises signing the deployable code branch with a production certificate. In an example implementation, the branch signing logic 524 signs the deployable code branch 552 with the production certificate. The branch signing logic 524 generates a signing indicator 560, which indicates that the deployable code branch 552 is signed with the production certificate. In an aspect, the signing indicator 560 includes the production certificate. In accordance with the certificate embodiment, deploying the deployable code branch at step 406 comprises, in response to the request to deploy the build of the main codebase, deploying the deployable code branch as a result of the deployable code branch being signed with the production certificate. In an example implementation, in response to the deployment request 540, the branch deploying logic 526 deploys the deployable code branch 552 as a result of the signing indicator 560 indicating that the deployable code branch 552 is signed with the production certificate.

In an example pull request embodiment, the security policy specifies that merging an arbitrary change that is comprised in an arbitrary branch of the main codebase (e.g., main codebase 546) into the main codebase is conditioned on satisfaction of a prerequisite. The prerequisite comprises creation of a pull request (e.g., pull request 562), which requests merging the arbitrary change into the main codebase, and further comprises approval (e.g., approval 564) of the pull request. In accordance with this embodiment, the method of flowchart 400 further comprises committing a change that is comprised in the first branch of the main codebase. Committing the change comprises merging the change into the main codebase by performing at least first and second operations in satisfaction of the prerequisite. The first operation comprises creating a first pull request, which requests a merge of the change into the main codebase. The second operation comprises receiving approval of the first pull request as a result of the change complying with the security policy.

In an example implementation of the pull request embodiment, the change commit logic 514 performs a change commit 568, which commits a change in the first branch 542 of the main codebase 546. Performing the change commit 568 includes merging the change into the main codebase 546 by performing at least first and second operations in satisfaction of the prerequisite. The first operation includes creating the pull request 562, which requests a merge of the change into the main codebase 546. The second operation includes receiving approval 564 of the pull request 562 as a result of the change complying with the security policy. In an aspect, the change commit logic 514 generates pull request information 566 as a result of performing the first and second operations. The pull request information 566 indicates that the pull request 562 is created and that the approval 564 of the pull request 562 is received.

In an aspect of the pull request embodiment, the first branch is stored in the designated store at step 402 as a result of the first pull request being created and the approval of the first pull request being received. In an example implementation of this aspect, the branch storage logic 516 stores the first branch 542 in the designated store 510 as a result of the change commit logic 514 creating the pull request 562 and the change commit logic 514 receiving the approval 564 of the pull request 562. In an aspect, the branch storage logic 516 stores the first branch 542 in the designated store 510 based on receipt of the pull request information 566. In an example of this aspect, the branch storage logic 516 stores the first branch 542 in the designated store 510 as a result of the pull request information 566 indicating that the pull request 562 is created and that the approval 562 of the pull request 562 is received.

In another aspect of the pull request embodiment, the first branch is converted into the deployable code branch at step 404 as a result of the first pull request being created during a time period that temporally follows storage of the first branch in the designated store and the approval of the first pull request being received. In an aspect, the pull request information 566 indicates a time instance at which the pull request 562 is created. In accordance with this aspect, the branch conversion logic 520 determines that the pull request 562 is created during the time period that temporally follows the storage of the first branch 542 in the designated store 510 by determining that the time instance indicated by the pull request information 566 is included in the time period that temporally follows the storage of the first branch 542 in the designated store 510.

In yet another aspect of the pull request embodiment, the approval of the first pull request is received as a result of the change being reviewed by a number of reviewers that is greater than or equal to a threshold number. The threshold number is greater than or equal to two. For instance, the threshold number may be any positive integer that is greater than or equal to two.

In still another aspect of the pull request embodiment, the approval of the first pull request is received as a result of the change being reviewed by a designated reviewer (e.g., a required reviewer) that is identified by the security policy. In an example, the security policy specifies an identifier (e.g., a name) associated with the designated reviewer. For instance, the identifier may uniquely identify the designated reviewer. In another example, the approval of the first pull request is received as a result of the change being reviewed by a plurality of designated reviewers (e.g., required reviewers) that are identified by the security policy. For instance, the security policy may specify an identifier (e.g., a name) for each designated user in the plurality of designated reviewers. Each identifier may uniquely identify the respective designated reviewer.

In another aspect of the pull request embodiment, the approval of the first pull request is received as a result of the first pull request being created at a designated (e.g., required) computing system, which is identified (e.g., uniquely identified) by the security policy. In an example, the security policy specifies an Internet Protocol (IP) address of the designated computing system.

In yet another aspect of the pull request embodiment, the approval of the first pull request is received further as a result of the security policy remaining unchanged since the creation of the first branch of the main codebase.

In still another aspect of the pull request embodiment, the approval of the first pull request is received further as a result of the security policy remaining enforced since the creation of the first branch of the main codebase. In an example, the security policy remaining enforced since the creation of the first branch of the main codebase requires that the security policy has not been turned off (e.g., switched from an on state to an off state) and then turned back on (e.g., switched from the off state back to the on state) since the creation of the first branch.

It will be recognized that the computing system 500 may not include one or more of the security policy compliance-based deployment logic 508, the designated store 510, the main store 512, the change commit logic 514, the branch storage logic 516, the branch conversion logic 520, the deployment logic 522, the branch signing logic 524, and/or the branch deploying logic 526. Furthermore, the computing system 500 may include components in addition to or in lieu of the security policy compliance-based deployment logic 508, the designated store 510, the main store 512, the change commit logic 514, the branch storage logic 516, the branch conversion logic 520, the deployment logic 522, the branch signing logic 524, and/or the branch deploying logic 526.

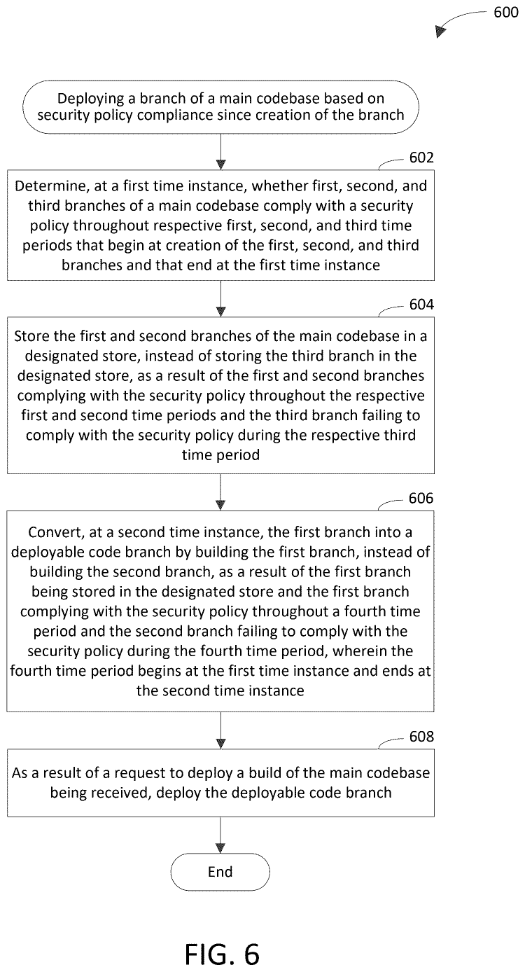

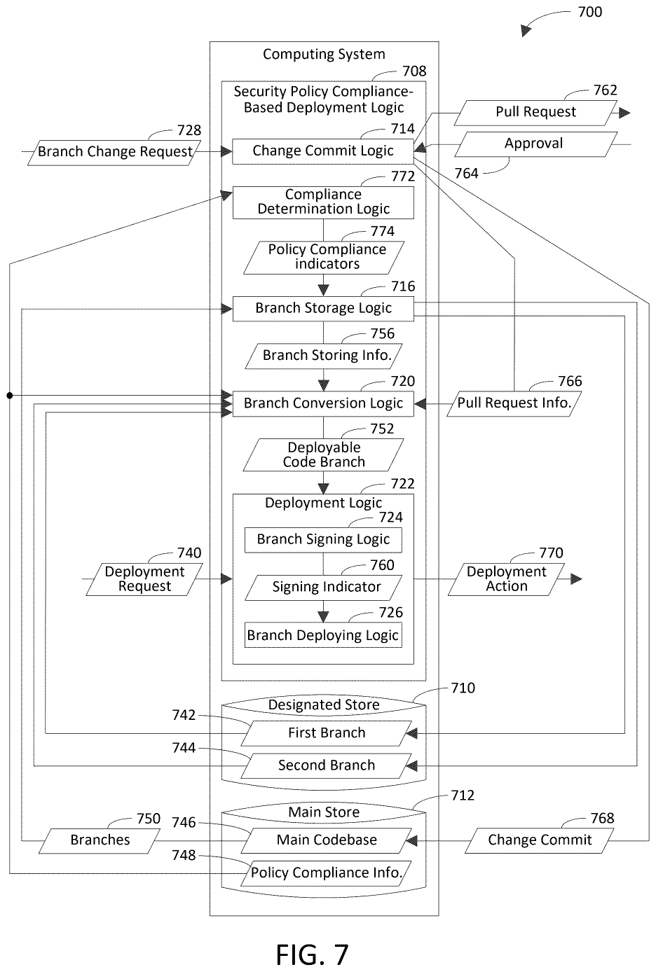

FIG. 6 depicts a flowchart 600 of another example method for deploying a branch of a main codebase based on security policy compliance since creation of the branch in accordance with an embodiment. Flowchart 600 may be performed by the first server(s) 106A shown in FIG. 1, for example. For illustrative purposes, flowchart 600 is described with respect to a computing system 700 shown in FIG. 7, which is an example implementation of the first server(s) 106A. As shown in FIG. 7, the computing system 700 includes security policy compliance-based deployment logic 708, a designated store 710, and a main store 712. The security policy compliance-based deployment logic 708 includes change commit logic 714, branch storage logic 716, branch conversion logic 720, deployment logic 722, and compliance determination logic 772. The deployment logic 722 includes branch signing logic 724 and branch deploying logic 726. Each of the designated store 710 and the main store 712 may be any suitable type of store. For instance, each of the designated store 710 and the main store 712 may be a relational database, an entity-relationship database, an object database, an object relational database, an extensible markup language (XML) database, etc. The designated store 710 is shown to store a first branch 742 of a main codebase 746 and a second branch 744 of the main codebase 746 for non-limiting, illustrative purposes. The main store 712 is shown to store the main codebase 746 and policy compliance information 748 for non-limiting, illustrative purposes. Further structural and operational embodiments will be apparent to persons skilled in the relevant art(s) based on the discussion regarding flowchart 600.

As shown in FIG. 6, the method of flowchart 600 begins at step 602. In step 602, at a first time instance, a determination is made whether first, second, and third branches of a main codebase comply with a security policy throughout respective first, second, and third time periods that begin at creation of the first, second, and third branches and that end at the first time instance. In an example implementation, at the first time instance, the compliance determination logic 772 determines whether a first branch 742, a second branch 744, and a third branch of a main codebase 746 comply with the security policy throughout respective first, second, and third time periods that begin at creation of the first branch 742, the second branch 744, and the third branch, respectively, and that end at the first time instance. The compliance determination logic 772 generates policy compliance indicators 774, which indicate whether the first branch 742, the second branch 744, and the third branch of the main codebase 746 comply with the security policy throughout the respective first, second, and third time periods.

In an aspect of this implementation, the compliance determination logic 772 determines that the first branch 742 and the second branch 744 comply with the security policy throughout the respective first and second time periods and that the third branch fails to comply with the security policy during the respective third time period based on (e.g., based at least on) the policy compliance information 748 indicating occurrence of conditions. The conditions include the first branch 742 and the second branch 744 complying with the security policy throughout the respective first and second time periods. The conditions further include the third branch failing to comply with the security policy during the respective third time period. In accordance with this aspect, the compliance determination logic 772 configures the generates policy compliance indicators 774 to indicate that the first branch 742 and the second branch 744 comply with the security policy throughout the respective first and second time periods and that the third branch fails to comply with the security policy during the respective third time period.

At step 604, the first and second branches of the main codebase are stored in a designated store instead of the third branch of the main codebase being stored in the designated store. Step 604 is performed as a result of the first and second branches complying with the security policy throughout the respective first and second time periods and the third branch failing to comply with the security policy during the respective third time period. In an example implementation, the branch storing logic 716 stores the first branch 742 and the second branch 744 of the main codebase 746 in the designated store 710, instead of storing the third branch of the main codebase 746 in the designated store 710, as a result of the policy compliance indicators 774 indicating occurrence of conditions. The conditions include the first branch 742 and the second branch 744 complying with the security policy throughout the respective first and second time periods. The conditions further include the third branch failing to comply with the security policy during the respective third time period. In an aspect, the branch storing logic 716 retrieves branches 750 of the main codebase 746 from the main store 712. The branches 750 include the first branch 742, the second branch 744, and the third branch. The branch storage logic 716 generates branch storing information 756, which indicates that the first branch 742 and the second branch 744 are stored in the designated store 710. In an example, the branch storing information 756 further indicates that the third branch is not stored in the designated store 710.

At step 606, at a second time instance, the first branch is converted into a deployable code branch by building the first branch instead of building the second branch. Step 606 is performed as a result of the first branch being stored in the designated store and the first branch complying with the security policy throughout a fourth time period and the second branch failing to comply with the security policy during the fourth time period. The fourth time period begins at the first time instance and ends at the second time instance. In an example implementation, at a second time instance, the branch conversion logic 720 converts the first branch 742 into a deployable code branch 752 by building the first branch 742, instead of building the second branch 744, as a result of conditions being satisfied. The conditions include the first branch 742 being stored in the designated store 710. The conditions further include the first branch 742 complying with the security policy throughout the fourth time period. The conditions further include the second branch 744 failing to comply with the security policy during the fourth time period. In an aspect of this implementation, the branch conversion logic 720 analyzes the branch storing information 756 to determine that the first branch 742 and the second branch 744 are stored in the designated store 710. In another aspect of this implementation, the branch conversion logic 720 analyzes the policy compliance information 748 to determine that the first branch 742 complies with the security policy throughout the fourth time period and to determine that the second branch 744 fails to comply with the security policy during the fourth time period. In an example of this aspect, the policy compliance information 748 indicates that that the first branch 742 complies with the security policy throughout the fourth time period by associating the first branch 742 with a first value (e.g., a first binary value, such as “1”). In accordance with this example, the policy compliance information 748 indicates that the second branch 744 fails to comply with the security policy during the fourth time period by associating the second branch 744 with a second value (e.g., a second binary value, such as “0”). The first value and the second value are different.

At step 608, as a result of a request to deploy a build of the main codebase being received, the deployable code branch is deployed. In an example implementation, as a result of a deployment request 740 being received, the deployment logic 722 performs a deployment action 770, which includes deploying the deployable code branch 752. The deployment request 740 requests deployment of a build of the main codebase 746. In an aspect, the deployment logic 722 performs the deployment action 770 as a result of the first branch 742 being stored in the designated store 710 and the first branch 742 complying with the security policy throughout the fourth time period.

In some example embodiments, one or more steps 602, 604, 606, and/or 608 of flowchart 600 may not be performed. Moreover, steps in addition to or in lieu of steps 602, 604, 606, and/or 608 may be performed. For instance, in an example certificate embodiment, the method of flowchart 600 further comprises signing the deployable code branch with a production certificate. In an example implementation, the branch signing logic 724 signs the deployable code branch 752 with the production certificate. The branch signing logic 724 generates a signing indicator 760, which indicates that the deployable code branch 752 is signed with the production certificate. In an aspect, the signing indicator 760 includes the production certificate. In accordance with the certificate embodiment, deploying the deployable code branch at step 608 comprises, as the result of the request to deploy the build of the main codebase being received and the deployable code branch being signed with the production certificate, deploying the deployable code branch. In an example implementation, the branch deploying logic 726 deploys the deployable code branch 752 as the result of the deployment request 740 being received and the deployable code branch 752 being signed with the production certificate.

In an example pull request embodiment, the security policy specifies that merging an arbitrary change that is comprised in an arbitrary branch of the main codebase (e.g., main codebase 746) into the main codebase is conditioned on satisfaction of a prerequisite. The prerequisite comprises creation of a pull request (e.g., pull request 762), which requests merging the arbitrary change into the main codebase, and further comprises approval (e.g., approval 764) of the pull request. In accordance with this embodiment, the method of flowchart 600 further comprises committing a change that is comprised in the first branch of the main codebase. Committing the change comprises merging the change into the main codebase by performing at least first and second operations in satisfaction of the prerequisite. The first operation comprises creating a first pull request, which requests a merge of the change into the main codebase. The second operation comprises receiving approval of the first pull request as a result of the change complying with the security policy.

In an example implementation of the pull request embodiment, the change commit logic 714 performs a change commit 768, which commits a change in the first branch 742 of the main codebase 746. Performing the change commit 768 includes merging the change into the main codebase 746 by performing at least first and second operations in satisfaction of the prerequisite. The first operation includes creating the pull request 762, which requests a merge of the change into the main codebase 746. The second operation includes receiving approval 764 of the pull request 762 as a result of the change complying with the security policy. In an aspect, the change commit logic 714 generates pull request information 766 as a result of performing the first and second operations. The pull request information 766 indicates that the pull request 762 is created and that the approval 764 of the pull request 762 is received.

In an aspect of the pull request embodiment, the first branch is stored in the designated store at step 604 as a result of the first pull request being created and the approval of the first pull request being received. In an example implementation of this aspect, the branch storage logic 716 stores the first branch 742 in the designated store 710 as a result of the change commit logic 714 creating the pull request 762 and the change commit logic 714 receiving the approval 764 of the pull request 762. In an aspect, the branch storage logic 716 stores the first branch 742 in the designated store 710 based on receipt of the pull request information 766. In an example of this aspect, the branch storage logic 716 stores the first branch 742 in the designated store 710 as a result of the pull request information 766 indicating that the pull request 762 is created and that the approval 762 of the pull request 762 is received.

In another aspect of the pull request embodiment, the first branch is converted into the deployable code branch at step 606 as a result of the first pull request being created during a time period that temporally follows storage of the first branch in the designated store and the approval of the first pull request being received. In an aspect, the pull request information 766 indicates a time instance at which the pull request 762 is created. In accordance with this aspect, the branch conversion logic 720 determines that the pull request 762 is created during the time period that temporally follows the storage of the first branch 742 in the designated store 710 by determining that the time instance indicated by the pull request information 766 is included in the time period that temporally follows the storage of the first branch 742 in the designated store 710.

In yet another aspect of the pull request embodiment, the approval of the first pull request is received as a result of the change being reviewed by a number of reviewers that is greater than or equal to a threshold number. The threshold number is greater than or equal to two. For instance, the threshold number may be any positive integer that is greater than or equal to two.

In still another aspect of the pull request embodiment, the approval of the first pull request is received as a result of the change being reviewed by a designated reviewer (e.g., a required reviewer) that is identified by the security policy. In an example, the security policy specifies an identifier (e.g., a name) associated with the designated reviewer. For instance, the identifier may uniquely identify the designated reviewer. In another example, the approval of the first pull request is received as a result of the change being reviewed by a plurality of designated reviewers (e.g., required reviewers) that are identified by the security policy. For instance, the security policy may specify an identifier (e.g., a name) for each designated user in the plurality of designated reviewers. Each identifier may uniquely identify the respective designated reviewer.

In another aspect of the pull request embodiment, the approval of the first pull request is received as a result of the first pull request being created at a designated (e.g., required) computing system, which is identified (e.g., uniquely identified) by the security policy. In an example, the security policy specifies an Internet Protocol (IP) address of the designated computing system.

In yet another aspect of the pull request embodiment, the approval of the first pull request is received further as a result of the security policy remaining unchanged since the creation of the first branch of the main codebase.

In still another aspect of the pull request embodiment, the approval of the first pull request is received further as a result of the security policy remaining enforced since the creation of the first branch of the main codebase. In an example, the security policy remaining enforced since the creation of the first branch of the main codebase requires that the security policy has not been turned off (e.g., switched from an on state to an off state) and then turned back on (e.g., switched from the off state back to the on state) since the creation of the first branch.

It will be recognized that the computing system 700 may not include one or more of the security policy compliance-based deployment logic 708, the designated store 710, the main store 712, the change commit logic 714, the branch storage logic 716, the branch conversion logic 720, the deployment logic 722, the branch signing logic 724, the branch deploying logic 726, and/or the compliance determination logic 772. Furthermore, the computing system 700 may include components in addition to or in lieu of the security policy compliance-based deployment logic 708, the designated store 710, the main store 712, the change commit logic 714, the branch storage logic 716, the branch conversion logic 720, the deployment logic 722, the branch signing logic 724, the branch deploying logic 726, and/or the compliance determination logic 772.

Any one or more steps 202, 204, 206, 208, and/or 210 of flowchart 200 shown in FIG. 2; any one or more steps 402, 404, and/or 406 of flowchart 400 shown in FIG. 4; and/or any one or more steps 602, 604, 606, and/or 608 of flowchart 600 shown in FIG. 6 may be performed automatically.

Although the operations of some of the disclosed methods are described in a particular, sequential order for convenient presentation, it should be understood that this manner of description encompasses rearrangement, unless a particular ordering is required by specific language set forth herein. For example, operations described sequentially may in some cases be rearranged or performed concurrently. Moreover, for the sake of simplicity, the attached figures may not show the various ways in which the disclosed methods may be used in conjunction with other methods.

Any one or more of the security policy compliance-based deployment logic 108, the security policy compliance-based deployment logic 608, the communication analysis logic 612, the reference analysis logic 614, the explanation analysis logic 616, the AI model 618, the security action logic 620, flowchart 200, flowchart 300, flowchart 400, and/or flowchart 500 may be implemented in hardware, software, firmware, or any combination thereof.

For example, any one or more of the security policy compliance-based deployment logic 108, the security policy compliance-based deployment logic 308, the change commit logic 314, the branch storage logic 316, the criterion satisfaction logic 318, the deployable branch generation logic 320, the deployment logic 322, the branch signing logic 324, the branch deploying logic 326, the security policy compliance-based deployment logic 508, the change commit logic 514, the branch storage logic 516, the branch conversion logic 520, the deployment logic 522, the branch signing logic 524, the branch deploying logic 526, the security policy compliance-based deployment logic 708, the change commit logic 714, the branch storage logic 716, the branch conversion logic 720, the deployment logic 722, the branch signing logic 724, the branch deploying logic 726, the compliance determination logic 772, flowchart 200, flowchart 400, and/or flowchart 600 may be implemented, at least in part, as computer program code configured to be executed in one or more processors.

In another example, any one or more of the security policy compliance-based deployment logic 108, the security policy compliance-based deployment logic 308, the change commit logic 314, the branch storage logic 316, the criterion satisfaction logic 318, the deployable branch generation logic 320, the deployment logic 322, the branch signing logic 324, the branch deploying logic 326, the security policy compliance-based deployment logic 508, the change commit logic 514, the branch storage logic 516, the branch conversion logic 520, the deployment logic 522, the branch signing logic 524, the branch deploying logic 526, the security policy compliance-based deployment logic 708, the change commit logic 714, the branch storage logic 716, the branch conversion logic 720, the deployment logic 722, the branch signing logic 724, the branch deploying logic 726, the compliance determination logic 772, flowchart 200, flowchart 400, and/or flowchart 600 may be implemented, at least in part, as hardware logic/electrical circuitry. Such hardware logic/electrical circuitry may include one or more hardware logic components. Examples of a hardware logic component include but are not limited to a field-programmable gate array (FPGA), an application-specific integrated circuit (ASIC), an application-specific standard product (ASSP), a system-on-a-chip system (SoC), a complex programmable logic device (CPLD), etc. For instance, a SoC may include an integrated circuit chip that includes one or more of a processor (e.g., a microcontroller, microprocessor, digital signal processor (DSP), etc.), memory, one or more communication interfaces, and/or further circuits and/or embedded firmware to perform its functions.

### II. Further Discussion of Some Example Embodiments

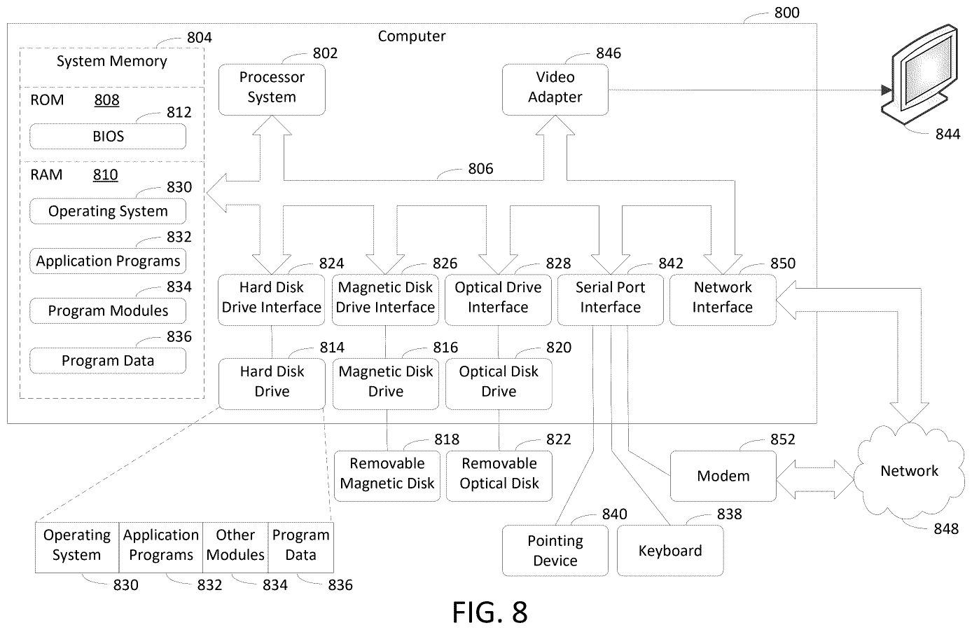

(A1) An example system (FIG. 1, 102A-102M, 106A-106N; FIGS. 3, 300; FIGS. 8, 800) comprises a processor system (FIGS. 8, 802) and a memory (FIGS. 8, 804, 808, 810) that stores computer-executable instructions. The computer-executable instructions are executable by the processor system to at least, as a result of a first branch (FIGS. 3, 342) of a main codebase (FIGS. 3, 346) undergoing an official build, store (FIGS. 2, 202) the first branch in a designated store (FIGS. 3, 310). The computer-executable instructions are executable by the processor system further to at least, as a result of verifying that a second branch (FIGS. 3, 344) of the main codebase has complied with a security policy since creation of the second branch, store (FIGS. 2, 204) the second branch in the designated store. The computer-executable instructions are executable by the processor system further to at least determine (FIGS. 2, 206) that a deployment criterion is satisfied by verifying that the first branch and the second branch are stored in the designated store and that the first branch and the second branch have complied with the security policy since being stored in the designated store. The computer-executable instructions are executable by the processor system further to at least, as a result of the deployment criterion being satisfied, generate (FIGS. 2, 208) a first deployable code branch (FIGS. 3, 352) and a second deployable code branch (FIGS. 3, 354) by building the first branch and the second branch, respectively. The computer-executable instructions are executable by the processor system further to at least, as a result of a request (FIGS. 3, 340) to deploy a build of the main codebase being received, deploy (FIGS. 2, 210) the first deployable code branch and the second deployable code branch.
(A2) In the example system of A1, wherein the computer-executable instructions are executable by the processor system to at least: sign the first deployable code branch and the second deployable code branch with a production certificate; and as the result of the request to deploy the build of the main codebase being received and the first deployable code branch and the second deployable code branch being signed with the production certificate, deploy the first deployable code branch and the second deployable code branch.
(A3) In the example system of any one of A1-A2, wherein the security policy specifies that merging an arbitrary change that is comprised in an arbitrary branch of the main codebase into the main codebase is conditioned on satisfaction of a prerequisite, the prerequisite comprising creation of a pull request, which requests merging the arbitrary change into the main codebase, and further comprising approval of the pull request; wherein the computer-executable instructions are executable by the processor system further to at least: commit a change in a specified branch of the main codebase, which comprises merging the change into the main codebase by performing the following operations in satisfaction of the prerequisite: create a first pull request, which requests a merge of the change into the main codebase; and receive approval of the first pull request as a result of the change complying with the security policy; and wherein the specified branch is the first branch or the second branch.
(A4) In the example system of any one of A1-A3, wherein the computer-executable instructions are executable by the processor system to at least: store the second branch of the main codebase in the designated store as a result of the first pull request being created and the approval of the first pull request being received.
(A5) In the example system of any one of A1-A4, wherein the computer-executable instructions are executable by the processor system to determine that the deployment criterion is satisfied by performing the following operations: determine that the first pull request is created during a time period that temporally follows storage of the specified branch in the designated store; and determine that the approval of the first pull request is received; and wherein the computer-executable instructions are executable by the processor system to generate the first deployable code branch and the second deployable code branch by building the specified branch as a result of the first pull request being created during the time period that temporally follows the storage of the specified branch in the designated store and the approval of the first pull request being received.
(A6) In the example system of any one of A1-A5, wherein the computer-executable instructions are executable by the processor system to at least: receive the approval of the first pull request as a result of the change being reviewed by a number of reviewers that is greater than or equal to a threshold number, wherein the threshold number is greater than or equal to two.
(A7) In the example system of any one of A1-A6, wherein the computer-executable instructions are executable by the processor system to at least: receive the approval of the first pull request as a result of the change being reviewed by a designated reviewer that is identified by the security policy.
(A8) In the example system of any one of A1-A7, wherein the computer-executable instructions are executable by the processor system to at least: receive the approval of the first pull request as a result of the first pull request being created at a designated computing system, which is identified by the security policy.
(A9) In the example system of any one of A1-A8, wherein the computer-executable instructions are executable by the processor system to at least: receive the approval of the first pull request further as a result of the security policy remaining unchanged since the creation of the second branch of the main codebase.
(A10) In the example system of any one of A1-A9, wherein the computer-executable instructions are executable by the processor system to at least: receive the approval of the first pull request further as a result of the security policy remaining enforced since the creation of the second branch of the main codebase.
(B1) An example method is implemented by a computing system (FIG. 1, 102A-102M, 106A-106N; FIGS. 5, 500; FIGS. 8, 800). The method comprises storing (FIGS. 4, 402) a first branch (FIGS. 5, 542) of a main codebase (FIGS. 5, 546) in a designated store (FIGS. 5, 510), instead of storing a second branch of the main codebase in the designated store, as a result of the first branch continuously complying with a security policy since creation of the first branch and the second branch failing to continuously comply with the security policy since creation of the second branch. The method further comprises, as a result of the first branch of the main codebase being stored in the designated store and the first branch continuing to comply with the security policy since the first branch was stored in the designated store, converting (FIGS. 4, 404) the first branch into a deployable code branch (FIGS. 5, 552) by building the first branch. The method further comprises, in response to a request (FIGS. 5, 540) to deploy a build of the main codebase, deploying (FIGS. 4, 406) the deployable code branch.
(B2) In the example method of B1, further comprising: signing the deployable code branch of the main codebase with a production certificate; and wherein deploying the deployable code branch comprises: in response to the request to deploy the build of the main codebase, deploying the deployable code branch of the main codebase as a result of the deployable code branch being signed with the production certificate.
(B3) In the example method of any one of B1-B2, wherein the security policy specifies that merging an arbitrary change that is comprised in an arbitrary branch of the main codebase into the main codebase is conditioned on satisfaction of a prerequisite, the prerequisite comprising creation of a pull request, which requests merging the arbitrary change into the main codebase, and further comprising approval of the pull request; and wherein the method further comprises: committing a change that is comprised in the first branch of the main codebase, the committing comprising merging the change into the main codebase by performing the following operations in satisfaction of the prerequisite: creating a first pull request, which requests a merge of the change into the main codebase; and receiving approval of the first pull request as a result of the change complying with the security policy.
(B4) In the example method of any one of B1-B3, wherein storing the first branch in the designated store comprises: storing the first branch of the main codebase in the designated store as a result of the first pull request being created and the approval of the first pull request being received.
(B5) In the example method of any one of B1-B4, wherein converting the first branch into the deployable code branch comprises: converting the first branch of the main codebase into the deployable code branch as a result of the first pull request being created during a time period that temporally follows storage of the first branch in the designated store and the approval of the first pull request being received.
(B6) In the example method of any one of B1-B5, wherein the approval of the first pull request is received as a result of the change being reviewed by a number of reviewers that is greater than or equal to a threshold number, wherein the threshold number is greater than or equal to two. (B17) In the example method of any one of B1-B6, wherein the approval of the first pull request is received as a result of the change being reviewed by a designated reviewer that is identified by the security policy.
(B8) In the example method of any one of B1-B7, wherein the approval of the first pull request is received as a result of the first pull request being created at a designated computing system, which is identified by the security policy.
(B9) In the example method of any one of B1-B8, wherein the approval of the first pull request is received further as a result of the security policy remaining unchanged since the creation of the first branch of the main codebase.
(B10) In the example method of any one of B1-B9, wherein the approval of the first pull request is received further as a result of the security policy remaining enforced since the creation of the first branch of the main codebase.
(C1) An example computer program product (FIGS. 8, 818, 822) comprises a computer-readable storage medium having instructions recorded thereon for enabling a processor-based system (FIG. 1, 102A-102M, 106A-106N; FIGS. 7, 700; FIGS. 8, 800) to perform operations. The operations comprise determining (FIGS. 6, 602), at a first time instance, whether first (FIGS. 7, 742), second (FIGS. 7, 744), and third branches of a main codebase (FIGS. 7, 746) comply with a security policy throughout respective first, second, and third time periods that begin at creation of the first, second, and third branches and that end at the first time instance. The operations further comprise storing (FIGS. 6, 604) the first and second branches of the main codebase in a designated store (FIGS. 7, 710), instead of storing the third branch in the designated store, as a result of the first and second branches complying with the security policy throughout the respective first and second time periods and the third branch failing to comply with the security policy during the respective third time period. The operations further comprise converting (FIGS. 6, 606), at a second time instance, the first branch into a deployable code branch (FIGS. 7, 752) by building the first branch, instead of building the second branch, as a result of the first branch being stored in the designated store and the first branch complying with the security policy throughout a fourth time period and the second branch failing to comply with the security policy during the fourth time period. The fourth time period begins at the first time instance and ends at the second time instance. The operations further comprise, as a result of a request (FIGS. 7, 740) to deploy a build of the main codebase being received, deploying (FIGS. 6, 608) the deployable code branch.
(C2) In the example computer program product of C1, wherein the operations comprise: signing the deployable code branch with a production certificate; and as the result of the request to deploy the build of the main codebase being received and the deployable code branch being signed with the production certificate, deploying the deployable code branch.
(C3) In the example computer program product of any one of C1-C2, wherein the security policy specifies that merging an arbitrary change that is comprised in an arbitrary branch of the main codebase into the main codebase is conditioned on satisfaction of a prerequisite, the prerequisite comprising creation of a pull request, which requests merging the arbitrary change into the main codebase, and further comprising approval of the pull request; and wherein the operations further comprise: committing a change in the first branch of the main codebase, the committing comprising merging the change into the main codebase by performing the following operations in satisfaction of the prerequisite: creating a first pull request, which requests a merge of the change into the main codebase; and receiving approval of the first pull request as a result of the change complying with the security policy.
(C4) In the example computer program product of any one of C1-C3, wherein the operations comprise: storing the first branch of the main codebase in the designated store as a result of the first pull request being created and the approval of the first pull request being received.
(C5) In the example computer program product of any one of C1-C4, wherein the operations comprise: converting the first branch of the main codebase into the deployable code branch as a result of the first pull request being created during a time period that temporally follows storage of the first branch in the designated store and the approval of the first pull request being received.
(C6) In the example computer program product of any one of C1-C5, wherein the operations comprise: receiving the approval of the first pull request as a result of the change being reviewed by a number of reviewers that is greater than or equal to a threshold number, wherein the threshold number is greater than or equal to two.
(C7) In the example computer program product of any one of C1-C6, wherein the operations comprise: receiving the approval of the first pull request as a result of the change being reviewed by a designated reviewer that is identified by the security policy.
(C8) In the example computer program product of any one of C1-C7, wherein the operations comprise: receiving the approval of the first pull request as a result of the first pull request being created at a designated computing system, which is identified by the security policy.
(C9) In the example computer program product of any one of C1-C8, wherein the operations comprise: receiving the approval of the first pull request further as a result of the security policy remaining unchanged since the creation of the first branch of the main codebase.
(C10) In the example computer program product of any one of C1-C9, wherein the operations comprise: receiving the approval of the first pull request further as a result of the security policy remaining enforced since the creation of the first branch of the main codebase.

### III. Example Computer System

FIG. 8 depicts an example computer 800 in which embodiments may be implemented. Any one or more of the user devices 102A-102M and/or any one or more of the servers 106A-106N shown in FIG. 1, the computing system 300 shown in FIG. 3, the computing system 500 shown in FIG. 5, and/or the computing system 700 shown in FIG. 7 may be implemented using computer 800, including one or more features of computer 800 and/or alternative features. Computer 800 may be a general-purpose computing device in the form of a conventional personal computer, a mobile computer, or a workstation, for example, or computer 800 may be a special purpose computing device. The description of computer 800 provided herein is provided for purposes of illustration, and is not intended to be limiting. Embodiments may be implemented in further types of computer systems, as would be known to persons skilled in the relevant art(s).

As shown in FIG. 8, computer 800 includes a processor system 802, a system memory 804, and a bus 806 that couples various system components including system memory 804 to processor system 802. Bus 806 represents one or more of any of several types of bus structures, including a memory bus or memory controller, a peripheral bus, an accelerated graphics port, and a processor or local bus using any of a variety of bus architectures. System memory 804 includes read only memory (ROM) 808 and random access memory (RAM) 810. A basic input/output system 812 (BIOS) is stored in ROM 808.

Computer 800 also has one or more of the following drives: a hard disk drive 814 for reading from and writing to a hard disk, a magnetic disk drive 816 for reading from or writing to a removable magnetic disk 818, and an optical disk drive 820 for reading from or writing to a removable optical disk 822 such as a CD ROM, DVD ROM, or other optical media. Hard disk drive 814, magnetic disk drive 816, and optical disk drive 820 are connected to bus 806 by a hard disk drive interface 824, a magnetic disk drive interface 826, and an optical drive interface 828, respectively. The drives and their associated computer-readable storage media provide nonvolatile storage of computer-readable instructions, data structures, program modules and other data for the computer. Although a hard disk, a removable magnetic disk and a removable optical disk are described, other types of computer-readable storage media can be used to store data, such as flash memory cards, digital video disks, random access memories (RAMs), read only memories (ROM), and the like.

A number of program modules may be stored on the hard disk, magnetic disk, optical disk, ROM, or RAM. These programs include an operating system 830, one or more application programs 832, other program modules 834, and program data 836. Application programs 832 or program modules 834 may include, for example, computer program logic for implementing any one or more of (e.g., at least a portion of) the security policy compliance-based deployment logic 108, the security policy compliance-based deployment logic 308, the change commit logic 314, the branch storage logic 316, the criterion satisfaction logic 318, the deployable branch generation logic 320, the deployment logic 322, the branch signing logic 324, the branch deploying logic 326, the security policy compliance-based deployment logic 508, the change commit logic 514, the branch storage logic 516, the branch conversion logic 520, the deployment logic 522, the branch signing logic 524, the branch deploying logic 526, the security policy compliance-based deployment logic 708, the change commit logic 714, the branch storage logic 716, the branch conversion logic 720, the deployment logic 722, the branch signing logic 724, the branch deploying logic 726, the compliance determination logic 772, flowchart 200 (including any step of flowchart 200), flowchart 400 (including any step of flowchart 400), and/or flowchart 600 (including any step of flowchart 600), as described herein.

A user may enter commands and information into the computer 800 through input devices such as keyboard 838 and pointing device 840. Other input devices (not shown) may include a microphone, joystick, game pad, satellite dish, scanner, touch screen, camera, accelerometer, gyroscope, or the like. These and other input devices are often connected to the processor system 802 through a serial port interface 842 that is coupled to bus 806, but may be connected by other interfaces, such as a parallel port, game port, or a universal serial bus (USB).

A display device 844 (e.g., a monitor) is also connected to bus 806 via an interface, such as a video adapter 846. In addition to display device 844, computer 800 may include other peripheral output devices (not shown) such as speakers and printers.

Computer 800 is connected to a network 848 (e.g., the Internet) through a network interface 850 (e.g., a network or adapter), a modem 852, or other means for establishing communications over the network. Modem 852, which may be internal or external, is connected to bus 806 via serial port interface 842.

As used herein, the terms “computer program medium” and “computer-readable storage medium” are used to generally refer to media (e.g., non-transitory media) such as the hard disk associated with hard disk drive 814, removable magnetic disk 818, removable optical disk 822, as well as other media such as flash memory cards, digital video disks, random access memories (RAMs), read only memories (ROM), and the like. A computer-readable storage medium is not a signal, such as a carrier signal or a propagating signal. For instance, a computer-readable storage medium may not include a signal. Accordingly, a computer-readable storage medium does not constitute a signal per se. Such computer-readable storage media are distinguished from and non-overlapping with communication media (do not include communication media). Communication media embodies computer-readable instructions, data structures, program modules or other data in a modulated data signal such as a carrier wave. The term “modulated data signal” means a signal that has one or more of its characteristics set or changed in such a manner as to encode information in the signal. By way of example, and not limitation, communication media includes wireless media such as acoustic, RF, infrared and other wireless media, as well as wired media. Example embodiments are also directed to such communication media.

As noted above, computer programs and modules (including application programs 832 and other program modules 834) may be stored on the hard disk, magnetic disk, optical disk, ROM, or RAM. Such computer programs may also be received via network interface 850 or serial port interface 842. Such computer programs, when executed or loaded by an application, enable computer 800 to implement features of embodiments discussed herein. Accordingly, such computer programs represent controllers of the computer 800.

Example embodiments are also directed to computer program products comprising software (e.g., computer-readable instructions) stored on any computer-useable medium. Such software, when executed in one or more data processing devices, causes data processing device(s) to operate as described herein. Embodiments may employ any computer-useable or computer-readable medium, known now or in the future. Examples of computer-readable mediums include, but are not limited to storage devices such as RAM, hard drives, floppy disks, CD ROMs, DVD ROMs, zip disks, tapes, magnetic storage devices, optical storage devices, MEMS-based storage devices, nanotechnology-based storage devices, and the like.

It will be recognized that the disclosed technologies are not limited to any particular computer or type of hardware. Certain details of suitable computers and hardware are well known and need not be set forth in detail in this disclosure.

### IV. Conclusion

The foregoing detailed description refers to the accompanying drawings that illustrate exemplary embodiments of the present invention. However, the scope of the present invention is not limited to these embodiments, but is instead defined by the appended claims. Thus, embodiments beyond those shown in the accompanying drawings, such as modified versions of the illustrated embodiments, may nevertheless be encompassed by the present invention.

References in the specification to “one embodiment,” “an embodiment,” “an example embodiment,” or the like, indicate that the embodiment described may include a particular feature, structure, or characteristic, but every embodiment may not necessarily include the particular feature, structure, or characteristic. Moreover, such phrases are not necessarily referring to the same embodiment. Furthermore, when a particular feature, structure, or characteristic is described in connection with an embodiment, it is submitted that it is within the knowledge of one skilled in the relevant art(s) to implement such feature, structure, or characteristic in connection with other embodiments whether or not explicitly described.

Descriptors such as “first”, “second”, “third”, etc. are used to reference some elements discussed herein. Such descriptors are used to facilitate the discussion of the example embodiments and do not indicate a required order of the referenced elements, unless an affirmative statement is made herein that such an order is required.

Although the subject matter has been described in language specific to structural features and/or acts, it is to be understood that the subject matter defined in the appended claims is not necessarily limited to the specific features or acts described above. Rather, the specific features and acts described above are disclosed as examples of implementing the claims, and other equivalent features and acts are intended to be within the scope of the claims.

What is claimed is:

1. A system comprising:
a processor system; and
a memory that stores computer-executable instructions that are executable by the processor system to at least:
as a result of a first branch of a main codebase undergoing an official build, store the first branch in a designated store;
as a result of verifying that a second branch of the main codebase has complied with a security policy since creation of the second branch, store the second branch in the designated store;
determine that a deployment criterion is satisfied by verifying that the first branch and the second branch are stored in the designated store and that the first branch and the second branch have complied with the security policy since being stored in the designated store;
as a result of the deployment criterion being satisfied, generate a first deployable code branch and a second deployable code branch by building the first branch and the second branch, respectively; and
as a result of a request to deploy a build of the main codebase being received, deploy the first deployable code branch and the second deployable code branch.

2. The system of claim 1, wherein the computer-executable instructions are executable by the processor system to at least:
sign the first deployable code branch and the second deployable code branch with a production certificate; and
as the result of the request to deploy the build of the main codebase being received and the first deployable code branch and the second deployable code branch being signed with the production certificate, deploy the first deployable code branch and the second deployable code branch.

3. The system of claim 1, wherein the security policy specifies that merging an arbitrary change that is comprised in an arbitrary branch of the main codebase into the main codebase is conditioned on satisfaction of a prerequisite, the prerequisite comprising creation of a pull request, which requests merging the arbitrary change into the main codebase, and further comprising approval of the pull request;
wherein the computer-executable instructions are executable by the processor system further to at least:
commit a change in a specified branch of the main codebase, which comprises merging the change into the main codebase by performing the following operations in satisfaction of the prerequisite:
create a first pull request, which requests a merge of the change into the main codebase; and
receive approval of the first pull request as a result of the change complying with the security policy; and
wherein the specified branch is the first branch or the second branch.

4. The system of claim 3, wherein the computer-executable instructions are executable by the processor system to at least:
store the second branch of the main codebase in the designated store as a result of the first pull request being created and the approval of the first pull request being received.

5. The system of claim 3, wherein the computer-executable instructions are executable by the processor system to determine that the deployment criterion is satisfied by performing the following operations:
determine that the first pull request is created during a time period that temporally follows storage of the specified branch in the designated store; and
determine that the approval of the first pull request is received; and
wherein the computer-executable instructions are executable by the processor system to generate the first deployable code branch and the second deployable code branch by building the specified branch as a result of the first pull request being created during the time period that temporally follows the storage of the specified branch in the designated store and the approval of the first pull request being received.

6. The system of claim 3, wherein the computer-executable instructions are executable by the processor system to at least:
receive the approval of the first pull request as a result of the change being reviewed by a number of reviewers that is greater than or equal to a threshold number, wherein the threshold number is greater than or equal to two.

7. The system of claim 3, wherein the computer-executable instructions are executable by the processor system to at least:
receive the approval of the first pull request as a result of the change being reviewed by a designated reviewer that is identified by the security policy.

8. The system of claim 3, wherein the computer-executable instructions are executable by the processor system to at least:
receive the approval of the first pull request as a result of the first pull request being created at a designated computing system, which is identified by the security policy.

9. The system of claim 3, wherein the computer-executable instructions are executable by the processor system to at least:
receive the approval of the first pull request further as a result of the security policy remaining at least one of unchanged since the creation of the second branch of the main codebase or enforced since the creation of the second branch of the main codebase.

10. A method implemented by a computing system, the method comprising:
storing a first branch of a main codebase in a designated store, instead of storing a second branch of the main codebase in the designated store, as a result of the first branch continuously complying with a security policy since creation of the first branch and the second branch failing to continuously comply with the security policy since creation of the second branch;
as a result of the first branch of the main codebase being stored in the designated store and the first branch continuing to comply with the security policy since the first branch was stored in the designated store, converting the first branch into a deployable code branch by building the first branch; and
in response to a request to deploy a build of the main codebase, deploying the deployable code branch.

11. The method of claim 10, further comprising:
signing the deployable code branch of the main codebase with a production certificate; and
wherein deploying the deployable code branch comprises:
in response to the request to deploy the build of the main codebase, deploying the deployable code branch of the main codebase as a result of the deployable code branch being signed with the production certificate.

12. The method of claim 10, wherein the security policy specifies that merging an arbitrary change that is comprised in an arbitrary branch of the main codebase into the main codebase is conditioned on satisfaction of a prerequisite, the prerequisite comprising creation of a pull request, which requests merging the arbitrary change into the main codebase, and further comprising approval of the pull request; and
wherein the method further comprises:
committing a change that is comprised in the first branch of the main codebase, the committing comprising merging the change into the main codebase by performing the following operations in satisfaction of the prerequisite:
creating a first pull request, which requests a merge of the change into the main codebase; and
receiving approval of the first pull request as a result of the change complying with the security policy.

13. The method of claim 12, wherein storing the first branch in the designated store comprises:
storing the first branch of the main codebase in the designated store as a result of the first pull request being created and the approval of the first pull request being received.

14. The method of claim 12, wherein converting the first branch into the deployable code branch comprises:
converting the first branch of the main codebase into the deployable code branch as a result of the first pull request being created during a time period that temporally follows storage of the first branch in the designated store and the approval of the first pull request being received.

15. The method of claim 12, wherein the approval of the first pull request is received as a result of the change being reviewed by a number of reviewers that is greater than or equal to a threshold number, wherein the threshold number is greater than or equal to two.

16. The method of claim 12, wherein the approval of the first pull request is received as a result of the change being reviewed by a designated reviewer that is identified by the security policy.

17. The method of claim 12, wherein the approval of the first pull request is received as a result of the first pull request being created at a designated computing system, which is identified by the security policy.

18. The method of claim 12, wherein the approval of the first pull request is received further as a result of the security policy remaining unchanged since the creation of the first branch of the main codebase.

19. The method of claim 12, wherein the approval of the first pull request is received further as a result of the security policy remaining enforced since the creation of the first branch of the main codebase.

20. A computer program product comprising a computer-readable storage medium having instructions recorded thereon for enabling a processor-based system to perform operations, the operations comprising:
determining, at a first time instance, whether first, second, and third branches of a main codebase comply with a security policy throughout respective first, second, and third time periods that begin at creation of the first, second, and third branches and that end at the first time instance;
storing the first and second branches of the main codebase in a designated store, instead of storing the third branch in the designated store, as a result of the first and second branches complying with the security policy throughout the respective first and second time periods and the third branch failing to comply with the security policy during the respective third time period;
converting, at a second time instance, the first branch into a deployable code branch by building the first branch, instead of building the second branch, as a result of the first branch being stored in the designated store and the first branch complying with the security policy throughout a fourth time period and the second branch failing to comply with the security policy during the fourth time period, wherein the fourth time period begins at the first time instance and ends at the second time instance; and
as a result of a request to deploy a build of the main codebase being received, deploying the deployable code branch.
